(19) United States
(12) Patent Application Publication
(10) Pub. No.: US 2024/0294781 A1
(43) Pub. Date: Sep. 5, 2024

(54) ELECTRODEPOSITABLE COATING COMPOSITIONS

(71) Applicant: PPG Industries Ohio, Inc., Cleveland, OH (US)

(72) Inventors: Brian Carl Okerberg, Gibsonia, PA (US); David Alfred Stone, Allison Park, PA (US)

(73) Assignee: PPG Industries Ohio, Inc., Cleveland, OH (US)

(21) Appl. No.: 18/571,312

(22) PCT Filed: Jul. 1, 2022
(86) PCT No.: PCT/US2022/073336

§ 371 Date: Dec. 18, 2023

Related U.S. Application Data
(60) Provisional application No. 63/217,517, filed on Jul. 1, 2021.

(51) Int. Cl. C09D 5/44; C09D 175/12

(52) U.S. Cl. CPC C09D 5/4465; C09D 5/448; C09D 175/12

(57) ABSTRACT

The present disclosure is directed to an electrodepositable coating composition comprising (a) a hydroxyl-functional addition polymer comprising constitutional units, at least 70% of which comprise formula (I) wherein each R¹ is independently one of hydrogen, an alkyl group, a substituted alkyl group, a cycloalkyl group, a substituted cycloalkyl group, an alkylcycloalkyl group, a substituted alkylcycloalkyl group, a cycloalkylalkyl group, a substituted cycloalkylalkyl group, an aryl group, a substituted aryl group, an alkylaryl group, a substituted alkylaryl group, a cycloalkylalkyl group, a substituted cycloalkylaryl group, an arylalkyl group, a substituted arylalkyl group, an arylcycloalkyl group, or a substituted arylcycloalkyl group, and the % based upon the total constitutional units of the hydroxyl-functional addition polymer; (b) an active hydrogen-containing, ionic salt group-containing film-forming polymer; (c) a curing agent; and (d) a curing catalyst.

### CROSS-REFERENCE TO RELATED APPLICATIONS

This application claims the benefit of U.S. Provisional Patent Application Ser. No. 63/217,517, filed on Jul. 1, 2021, which is incorporated herein by reference.

### FIELD

The present disclosure is directed towards an electrodepositable coating composition, coated substrates, and methods of coating substrates.

### BACKGROUND

Electrodeposition as a coating application method involves the deposition of a film-forming composition onto a conductive substrate under the influence of an applied electrical potential. Electrodeposition has gained popularity in the coatings industry because it provides higher paint utilization, outstanding corrosion resistance, and low environmental contamination as compared with non-electrophoretic coating methods. Both cationic and anionic electrodeposition processes are used commercially. An electrodepositable coating composition that provides crater control and edge coverage is desired.

### SUMMARY

The present disclosure provides an electrodepositable coating composition comprising (a) a hydroxyl-functional addition polymer comprising constitutional units, at least 70% of which comprise formula I:

—[—C(R¹)₂—C(R¹)(OH)—]— (I),

wherein each R¹ is independently one of hydrogen, an alkyl group, a substituted alkyl group, a cycloalkyl group, a substituted cycloalkyl group, an alkylcycloalkyl group, a substituted alkylcycloalkyl group, a cycloalkylalkyl group, a substituted cycloalkylalkyl group, an aryl group, a substituted aryl group, an alkylaryl group, a substituted alkylaryl group, a cycloalkylaryl group, a substituted cycloalkylaryl group, an arylalkyl group, a substituted arylalkyl group, an arylcycloalkyl group, or a substituted arylcycloalkyl group, and the % based upon the total constitutional units of the hydroxyl-functional addition polymer; (b) an active hydrogen-containing, ionic salt group-containing film-forming polymer; (c) a curing agent; and (d) an amine-containing curing catalyst and/or a zinc-containing curing catalyst.

The present disclosure also provides a method of coating a substrate comprising electrophoretically applying an electrodepositable coating composition comprising (a) a hydroxyl-functional addition polymer comprising constitutional units, at least 70% of which comprise formula I:

—[—C(R¹)₂—C(R¹)(OH)—]— (I),

wherein each R¹ is independently one of hydrogen, an alkyl group, a substituted alkyl group, a cycloalkyl group, a substituted cycloalkyl group, an alkylcycloalkyl group, a substituted alkylcycloalkyl group, a cycloalkylalkyl group, a substituted cycloalkylalkyl group, an aryl group, a substituted aryl group, an alkylaryl group, a substituted alkylaryl group, a cycloalkylaryl group, a substituted cycloalkylaryl group, an arylalkyl group, a substituted arylalkyl group, an arylcycloalkyl group, or a substituted arylcycloalkyl group, and the % based upon the total constitutional units of the hydroxyl-functional addition polymer; (b) an active hydrogen-containing, ionic salt group-containing film-forming polymer; (c) a curing agent; and (d) an amine-containing curing catalyst and/or a zinc-containing curing catalyst to at least a portion of the substrate.

The present disclosure further provides a coated substrate having a coating comprising (a) a hydroxyl-functional addition polymer comprising constitutional units, at least 70% of which comprise formula I:

—[—C(R¹)₂—C(R¹)(OH)—]— (I),

wherein each R¹ is independently one of hydrogen, an alkyl group, a substituted alkyl group, a cycloalkyl group, a substituted cycloalkyl group, an alkylcycloalkyl group, a substituted alkylcycloalkyl group, a cycloalkylalkyl group, a substituted cycloalkylalkyl group, an aryl group, a substituted aryl group, an alkylaryl group, a substituted alkylaryl group, a cycloalkylaryl group, a substituted cycloalkylaryl group, an arylalkyl group, a substituted arylalkyl group, an arylcycloalkyl group, or a substituted arylcycloalkyl group; (b) an active hydrogen-containing, ionic salt group-containing film-forming polymer different from the addition polymer; (c) a curing agent; and (d) an amine-containing curing catalyst and/or a zinc-containing curing catalyst.

### DETAILED DESCRIPTION

The present disclosure is directed to an electrodepositable coating composition comprising (a) a hydroxyl-functional addition polymer comprising constitutional units, at least 70% of which comprise formula I:

—[—C(R¹)₂—C(R¹)(OH)—]— (I),

wherein each R¹ is independently one of hydrogen, an alkyl group, a substituted alkyl group, a cycloalkyl group, a substituted cycloalkyl group, an alkylcycloalkyl group, a substituted alkylcycloalkyl group, a cycloalkylalkyl group, a substituted cycloalkylalkyl group, an aryl group, a substituted aryl group, an alkylaryl group, a substituted alkylaryl group, a cycloalkylaryl group, a substituted cycloalkylaryl group, an arylalkyl group, a substituted arylalkyl group, an arylcycloalkyl group, or a substituted arylcycloalkyl group, and the % based upon the total constitutional units of the hydroxyl-functional addition polymer; (b) an active hydrogen-containing, ionic salt group-containing film-forming polymer; (c) a curing agent; and (d) an amine-containing curing catalyst and/or a zinc-containing curing catalyst.

According to the present disclosure, the term “electrodepositable coating composition” refers to a composition that is capable of being deposited onto an electrically conductive substrate under the influence of an applied electrical potential.

### Hydroxyl-Functional Addition Polymer

The electrodepositable coating compositions of the present disclosure comprises a hydroxyl-functional addition polymer comprising constitutional units, at least 70% of which comprise formula I:

—[—C(R¹)₂—C(R¹)(OH)—]— (I),

wherein each R¹ is independently one of hydrogen, an alkyl group, a substituted alkyl group, a cycloalkyl group, a substituted cycloalkyl group, an alkylcycloalkyl group, a substituted alkylcycloalkyl group, a cycloalkylalkyl group, a substituted cycloalkylalkyl group, an aryl group, a substituted aryl group, an alkylaryl group, a substituted alkylaryl group, a cycloalkylaryl group, a substituted cycloalkylaryl group, an arylalkyl group, a substituted arylalkyl group, an arylcycloalkyl group, or a substituted arylcycloalkyl group, and the % based upon the total constitutional units of the hydroxyl-functional addition polymer.

Non-limiting examples of suitable alkyl radicals are methyl, ethyl, propyl, isopropyl, n-butyl, isobutyl, tert-butyl, amyl, hexyl, and 2-ethylhexyl.

Non-limiting examples of suitable cycloalkyl radicals are cyclobutyl, cyclopentyl, and cyclohexyl.

Non-limiting examples of suitable alkylcycloalkyl radicals are methylenecyclohexane, ethylenecyclohexane, and propane-1,3-diylcyclohexane.

Non-limiting examples of suitable cycloalkylalkyl radicals are 2-, 3- and 4-methyl-, -ethyl-, -propyl-, and -butylcyclohex-1-yl.

Non-limiting examples of suitable aryl radicals are phenyl, naphthyl, and biphenylyl.

Non-limiting examples of suitable alkylaryl radicals are benzyl-[sic], ethylene- and propane-1,3-diyl-benzene.

Non-limiting examples of suitable cycloalkylaryl radicals are 2-, 3-, and 4-phenylcyclohex-1-yl.

Non-limiting examples of suitable arylalkyl radicals are 2-, 3- and 4-methyl-, -ethyl-, -propyl-, and -butylphen-1-yl.

Non-limiting examples of suitable arylcycloalkyl radicals are 2-, 3-, and 4-cyclohexylphen-1-yl.

The above-described radicals R¹ may be substituted. Electron-withdrawing or electron-donating atoms or organic radicals may be used for this purpose.

Examples of suitable substituents are halogen atoms, such as chlorine or fluorine, nitrile groups, nitro groups, partly or fully halogenated, such as chlorinated and/or fluorinated, alkyl, cycloalkyl, alkylcycloalkyl, cycloalkylalkyl, aryl, alkylaryl, cycloalkylaryl, arylalkyl and arylcycloalkyl radicals, including those exemplified above, especially tert-butyl; aryloxy, alkyloxy and cycloalkyloxy radicals, especially phenoxy, naphthoxy, methoxy, ethoxy, propoxy, butyloxy or cyclohexyloxy; arylthio, alkylthio and cycloalkylthio radicals, especially phenylthio, naphthylthio, methylthio, ethylthio, propylthio, butylthio or cyclohexylthio; hydroxyl groups; and/or primary, secondary and/or tertiary amino groups, especially amino, N-methylamino, N-ethylamino, N-propylamino, N-phenylamino, N-cyclohexylamino, N,N-dimethylamino, N,N-diethylamino, N,N-dipropylamino, N,N-diphenylamino, N,N-dicyclohexylamino, N-cyclohexyl-N-methylamino or N-ethyl-N-methylamino.

R¹ may comprise, consist essentially of, or consist of hydrogen. For example, R¹ may comprise hydrogen in at least 80% of the constitutional units according to formula I, such as at least 90% of the constitutional units, such as at least 92% of the constitutional units, such as at least 95% of the constitutional units, such as 100% of the constitutional units.

As used herein, the term “addition polymer” refers to a polymerization product at least partially comprising the residue of unsaturated monomers.

The hydroxyl-functional addition polymer may comprise constitutional units according to formula I in an amount of at least 70%, such as at least 80%, such as at least 85%, such as at least 90%, the % based upon the total constitutional units of the hydroxyl-functional addition polymer. The hydroxyl-functional addition polymer may comprise constitutional units according to formula I in an amount of no more than 100%, such as no more than 95%, such as no more than 92%, such as no more than 90%, the % based upon the total constitutional units of the hydroxyl-functional addition polymer. The hydroxyl-functional addition polymer may comprise constitutional units according to formula I in an amount of 70% to 95% of the hydroxyl-functional addition polymer, such as 80% to 95%, such as such as 85% to 95%, such as 90% to 95%, such as 92% to 95%, such as 70% to 92%, such as 80% to 92%, such as such as 85% to 92%, such as 90% to 92%, such as 70% to 90%, such as 80% to 90%, such as such as 85% to 90%, the % based upon the total constitutional units of the hydroxyl-functional addition polymer.

According to the present disclosure, the hydroxyl-functional addition polymer may optionally further comprise constitutional units comprising the residue of a vinyl ester. The vinyl ester may comprise any suitable vinyl ester. For example, the vinyl ester may be according to the formula C(R¹)₂══C(R¹)(C(O)CH₃), wherein each R¹ is independently one of hydrogen, an alkyl group, a substituted alkyl group, a cycloalkyl group, a substituted cycloalkyl group, an alkylcycloalkyl group, a substituted alkylcycloalkyl group, a cycloalkylalkyl group, a substituted cycloalkylalkyl group, an aryl group, a substituted aryl group, an alkylaryl group, a substituted alkylaryl group, a cycloalkylaryl group, a substituted cycloalkylaryl group, an arylalkyl group, a substituted arylalkyl group, an arylcycloalkyl group, or a substituted arylcycloalkyl group. Non-limiting examples of suitable vinyl esters include vinyl acetate, vinyl formate, or any combination thereof.

The hydroxyl-functional addition polymer may be formed from polymerizing vinyl ester monomers to form an intermediate polymer comprising constitutional units comprising the residue of vinyl ester, and then hydrolyzing the constitutional units comprising the residue of vinyl ester of the intermediate polymer to form the hydroxyl-functional addition polymer. The residue of vinyl ester may comprise 70% of the constitutional units comprising the intermediate polymer, such as at least 80%, such as at least 85%, such as at least 90%, the % based upon the total constitutional units of the intermediate polymer. The residue of vinyl ester may comprise no more than 100% of the constitutional units comprising the intermediate polymer, such as no more than 95%, such as no more than 92%, such as no more than 90%, the % based upon the total constitutional units of the intermediate polymer. The residue of vinyl ester may comprise 70% to 95% of the hydroxyl-functional addition polymer, such as 80% to 95%, such as such as 85% to 95%, such as 90% to 95%, such as 92% to 95%, such as 70% to 92%, such as 80% to 92%, such as such as 85% to 92%, such as 90% to 92%, such as 70% to 90%, such as 80% to 90%, such as such as 85% to 90%, the % based upon the total constitutional units of the intermediate polymer.

The hydroxyl-functional addition polymer may have a theoretical hydroxyl equivalent weight of at least 30 g/hydroxyl group (“OH”), such as at least 35 g/OH, such as at least 40 g/OH, such as at least 44 g/OH. The hydroxyl-functional addition polymer may have a theoretical hydroxyl equivalent weight of no more than 200 g/OH, such as no more than 100 g/OH, such as no more than 60 g/OH, such as no more than 50 g/OH. The hydroxyl-functional addition polymer may have a theoretical hydroxyl equivalent weight of 30 g/OH to 200 g/OH, such as 30 g/OH to 100 g/OH, such as 30 g/OH to 60 g/OH, such as 30 g/OH to 50 g/OH, such as 35 g/OH to 200 g/OH, such as 35 g/OH to 100 g/OH, such as 35 g/OH to 60 g/OH, such as 35 g/OH to 50 g/OH, such as 40 g/OH to 200 g/OH, such as 40 g/OH to 100 g/OH, such as 40 g/OH to 60 g/OH, such as 40 g/OH to 50 g/OH, such as 44 g/OH to 200 g/OH, such as 44 g/OH to 100 g/OH, such as 44 g/OH to 60 g/OH, such as 44 g/OH to 50 g/OH. As used herein, the term “theoretical hydroxyl equivalent weight” refers to the weight in grams of hydroxyl-functional addition polymer resin solids divided by the theoretical equivalents of hydroxyl groups present in the hydroxyl-functional addition polymer, and may be calculated according to the following formula (a):

$$hydroxyl equivalent weight = \frac{total grams addition polymer resin solds}{theoretical equivalents of OH} \qquad ( a )$$

The hydroxyl-functional addition polymer may have a theoretical hydroxyl value of at least 1,000 mg KOH/gram addition polymer, such as at least 1,100 mg KOH/gram addition polymer, such as at least 1,150 mg KOH/gram addition polymer, such as at least 1,200 mg KOH/gram addition polymer. The hydroxyl-functional addition polymer may have a theoretical hydroxyl value of no more than 1,300 mg KOH/gram addition polymer, such as no more than 1,200 mg KOH/gram addition polymer, such as no more than 1,150 mg KOH/gram addition polymer. The hydroxyl-functional addition polymer may have a theoretical hydroxyl value of 1,000 to 1,300 mg KOH/gram addition polymer, such as 1,000 to 1,200 mg KOH/gram addition polymer, such as 1,000 to 1,150 mg KOH/gram addition polymer, such as 1,100 to 1,300 mg KOH/gram addition polymer, such as 1,100 to 1,200 mg KOH/gram addition polymer, such as 1,100 to 1,150 mg KOH/gram addition polymer, such as 1,150 to 1,300 mg KOH/gram addition polymer, such as 1,150 to 1,200 mg KOH/gram addition polymer. As used herein, the term “theoretical hydroxyl value” typically refers to the number of milligrams of potassium hydroxide required to neutralize the acetic acid taken up on acetylation of one gram of a chemical substance that contains free hydroxyl groups and was herein determined by a theoretical calculation of the number of free hydroxyl groups theoretically present in one gram of the hydroxyl-functional addition polymer.

The hydroxyl-functional addition polymer may have a number average molecular weight (Mₙ) of at least 5,000 g/mol, such as at least 20,000 g/mol, such as at least 25,000 g/mol, such as at least 50,000 g/mol, such as at least 75,000 g/mol, such as 100,000 g/mol, such as 125,000 g/mol, as determined by Gel Permeation Chromatography using polystyrene calibration standards. The hydroxyl-functional addition polymer may have a number average molecular weight (Mₙ) of no more than 500,000 g/mol, such as no more than 300,000 g/mol, such as no more than 200,000, such as no more than 125,000 g/mol, such as no more than 100,000 g/mol, as determined by Gel Permeation Chromatography using polystyrene calibration standards. The hydroxyl-functional addition polymer may have a number average molecular weight (Mₙ) of 5,000 g/mol to 500,000 g/mol, such as 5,000 g/mol to 300,000 g/mol, such as 5,000 g/mol to 200,000 g/mol, such as 5,000 g/mol to 125,000 g/mol, such as 5,000 g/mol to 100,000 g/mol, such as 20,000 g/mol to 500,000 g/mol, such as 20,000 g/mol to 300,000 g/mol, such as 20,000 g/mol to 200,000 g/mol, such as 20,000 g/mol to 125,000 g/mol, such as 20,000 g/mol to 100,000 g/mol, such as 25,000 g/mol to 500,000 g/mol, such as 25,000 g/mol to 300,000 g/mol, such as 25,000 to 200,000 g/mol, such as 25,000 g/mol to 125,000 g/mol, such as 25,000 g/mol to 100,000 g/mol, such as 50,000 g/mol to 500,000 g/mol, such as 50,000 g/mol to 300,000 g/mol, such as 50,000 g/mol to 200,000 g/mol, such as 50,000 g/mol to 125,000 g/mol, such as 50,000 g/mol to 100,000 g/mol, such as 75,000 g/mol to 500,000 g/mol, such as 75,000 g/mol to 300,000 g/mol, such as 75,000 g/mol to 200,000 g/mol, such as 75,000 g/mol to 125,000 g/mol, such as 100,000 g/mol to 500,000 g/mol, such as 100,000 g/mol to 300,000 g/mol, such as 100,000 g/mol to 200,000 g/mol, such as 100,000 g/mol to 125,000 g/mol, as determined by Gel Permeation Chromatography using polystyrene calibration standards.

The hydroxyl-functional addition polymer may have a weight average molecular weight (M_{w}) of at least 5,000 g/mol, such as at least 20,000 g/mol, such as at least 25,000 g/mol, such as at least 50,000 g/mol, such as at least 75,000 g/mol, such as 100,000 g/mol, such as 125,000 g/mol, such as at least 150,000 g/mol, such as at least 200,000 g/mol, such as at least 250,000 g/mol, such as at least 300,000 g/mol, as determined by Gel Permeation Chromatography using polystyrene calibration standards. The hydroxyl-functional addition polymer may have a weight average molecular weight (M_{w}) of no more than 500,000 g/mol, such as no more than 300,000 g/mol, such as no more than 200,000, such as no more than 125,000 g/mol, such as no more than 100,000 g/mol, as determined by Gel Permeation Chromatography using polystyrene calibration standards. The hydroxyl-functional addition polymer may have a weight average molecular weight of 5,000 g/mol to 500,000 g/mol, such as 5,000 g/mol to 300,000 g/mol, such as 5,000 g/mol to 200,000 g/mol, such as 5,000 g/mol to 125,000 g/mol, such as 5,000 g/mol to 100,000 g/mol, such as 20,000 g/mol to 500,000 g/mol, such as 20,000 g/mol to 300,000 g/mol, such as 20,000 g/mol to 200,000 g/mol, such as 20,000 g/mol to 125,000 g/mol, such as 20,000 g/mol to 100,000 g/mol, such as 25,000 g/mol to 500,000 g/mol, such as 25,000 g/mol to 300,000 g/mol, such as 25,000 to 200,000 g/mol, such as 25,000 g/mol to 125,000 g/mol, such as 25,000 g/mol to 100,000 g/mol, such as 50,000 g/mol to 500,000 g/mol, such as 50,000 g/mol to 300,000 g/mol, such as 50,000 g/mol to 200,000 g/mol, such as 50,000 g/mol to 125,000 g/mol, such as 50,000 g/mol to 100,000 g/mol, such as 75,000 g/mol to 500,000 g/mol, such as 75,000 g/mol to 300,000 g/mol, such as 75,000 g/mol to 200,000 g/mol, such as 75,000 g/mol to 125,000 g/mol, such as 100,000 g/mol to 500,000 g/mol, such as 100,000 g/mol to 300,000 g/mol, such as 100,000 g/mol to 200,000 g/mol, such as 100,000 g/mol to 125,000 g/mol, such as 125,000 g/mol to 500,000 g/mol, such as 125,000 g/mol to 300,000 g/mol, such as 125,000 g/mol to 200,000 g/mol, such as 150,000 g/mol to 500,000 g/mol, such as 150,000 g/mol to 300,000 g/mol, such as 150,000 g/mol to 200,000 g/mol, such as 200,000 g/mol to 500,000 g/mol, such as 200,000 g/mol to 300,000 g/mol, such as 250,000 g/mol to 500,000 g/mol, such as 250,000 g/mol to 300,000 g/mol, such as 300,000 g/mol to 500,000 g/mol, as determined by Gel Permeation Chromatography using polystyrene calibration standards.

As used herein, unless otherwise stated, the terms “number average molecular weight (Mₙ)” and “weight average molecular weight (M_{w})” means the number average molecular weight (M_{z}) and the weight average molecular weight (M_{w}) as determined by Gel Permeation Chromatography using Waters 2695 separation module with a Waters 410 differential refractometer (RI detector), polystyrene standards having molecular weights of from approximately 500 g/mol to 900,000 g/mol, dimethylformamide (DMF) with 0.05 M lithium bromide (LiBr) as the eluent at a flow rate of 0.5 m/min, and one Asahipak GF-510 HQ column for separation.

The hydroxyl-functional addition polymer may have a z-average molecular weight (M_{z}) of at least 10,000 g/mol, such as at least 15,000 g/mol, such as at least 20,000 g/mol, as determined by Gel Permeation Chromatography using polystyrene calibration standards. The hydroxyl-functional addition polymer may have a z-average molecular weight (M_{z}) of no more than 35,000 g/mol, such as no more than 25,000 g/mol, such as no more than 20,000 g/mol, as determined by Gel Permeation Chromatography using polystyrene calibration standards. The hydroxyl-functional addition polymer may have a z-average molecular weight (M_{z}) of 10,000 g/mol to 35,000 g/mol, such as 10,000 g/mol to 25,000 g/mol, such as 10,000 g/mol to 20,000 g/mol, such as 15,000 g/mol to 35,000 g/mol, such as 15,000 g/mol to 25,000 g/mol, such as 15,000 g/mol to 20,000 g/mol, such as 20,000 to 35,000 g/mol, such as 20,000 g/mol to 25,000 g/mol, as determined by Gel Permeation Chromatography using polystyrene calibration standards.

As used herein, unless otherwise stated, the terms “z-average molecular weight (M_{z})” means the z-average molecular weight (M_{z}) and the z-average molecular weight (M_{z}) as determined by Gel Permeation Chromatography using Waters 2695 separation module with a Waters 410 differential refractometer (RI detector), polystyrene standards having molecular weights of from approximately 500 g/mol to 900,000 g/mol, dimethylformamide (DMF) with 0.05 M lithium bromide (LiBr) as the eluent at a flow rate of 0.5 mL/min, and one Asahipak GF-510 HQ column for separation.

According to the present disclosure, a 4% by weight solution of the hydroxyl-functional addition polymer dissolved in water may have a viscosity of at least 10 cP as measured using a Brookfield synchronized-motor rotary type viscometer at 20° C., such as at least 15 cP, such as at least 20 cP. A 4% by weight solution of the hydroxyl-functional addition polymer dissolved in water may have a viscosity of no more than 110 cP as measured using a Brookfield synchronized-motor rotary type viscometer at 20° C., such as no more than 90 cP, such as no more than 70 cP, such as no more than 60 cP, such as no more than 50 cP, such as no more than 40 cP. A 4% by weight solution of the hydroxyl-functional addition polymer dissolved in water may have a viscosity of 10 to 110 cP as measured using a Brookfield synchronized-motor rotary type viscometer at 20° C., such as 10 to 90 cP, such as 10 to 70 cP, such as 10 to 50 cP, such as 10 to 40 cP, such as 15 to 110 cP, such as 15 to 90 cP, such as 15 to 70 cP, such as 15 to 60 cP, such as 15 to 50 cP, such as 15 to 40 cP, such as 20 to 110 cP, such as 20 to 90 cP, such as 20 to 70 cP, such as 20 to 60 cP, such as 20 to 50 cP, such as 20 to 40 cP.

The hydroxyl-functional addition polymer described above may be present in the electrodepositable coating composition in an amount of at least 0.01% by weight, such as at least 0.1% by weight, such as at least 0.3% by weight, such as at least 0.5% by weight, such as at least 0.75% by weight, such as 1% by weight, based on the total weight of the resin solids of the electrodepositable coating composition. The hydroxyl-functional addition polymer described above may be present in the electrodepositable coating composition in an amount no more than 5% by weight, such as no more than 3% by weight, such as no more than 2% by weight, such as no more than 1.5% by weight, such as no more than 1% by weight, such as n no more than 0.75% by weight, based on the total weight of the resin solids of the electrodepositable coating composition. The hydroxyl-functional addition polymer may be present in the electrodepositable coating composition in an amount of 0.01% to 5% by weight, such as 0.01% to 3% by weight, such as 0.01% to 2% by weight, such as 0.01% to 1.5% by weight, such as 0.01% to 1% by weight, such as 0.01% to 0.75% by weight, such as 0.1% to 5% by weight, such as 0.1% to 3% by weight, such as 0.1% to 2% by weight, such as 0.1% to 1.5% by weight, such as 0.1% to 1% by weight, such as 0.1% to 0.75% by weight, such as 0.3% to 5% by weight, such as 0.3% to 3% by weight, such as 0.3% to 2% by weight, such as 0.3% to 1.5% by weight, such as 0.3% to 1% by weight, such as 0.3% to 0.75% by weight, such as 0.5% to 5% by weight, such as 0.5% to 3% by weight, such as 0.5% to 2% by weight, such as 0.5% to 1.5% by weight, such as 0.5% to 1% by weight, such as 0.5% to 0.75% by weight, such as 1% to 5% by weight, such as 1% to 3% by weight, such as 1% to 2% by weight, such as 1% to 1.5% by weight, based on the total weight of the resin solids of the electrodepositable coating composition.

### Ionic Salt Group-Containing Film-Forming Polymer

The electrodepositable coating composition further comprises an ionic salt group-containing film-forming polymer. The ionic salt group-containing film-forming polymer may be different from the hydroxyl-functional addition polymer described above. The ionic salt group-containing film-forming polymer may comprise a cationic salt group containing film-forming polymer or an anionic salt group containing film-forming polymer.

The ionic salt group-containing film-forming polymer may optionally comprise a reaction product of a reaction mixture comprising (a) a polyepoxide; (b) di-functional chain extender; and (c) a mono-functional reactant.

The polyepoxide may comprise any suitable polyepoxide. For example, the polyepoxide may comprise a di-epoxide. Non-limiting examples of suitable polyepoxide include diglycidyl ethers of bisphenols, such as a diglycidyl ether of bisphenol A or bisphenol F.

The di-functional chain extender may comprise any suitable di-functional chain extender. For example, the di-functional chain extender may comprise a di-hydroxyl functional reactant, a di-carboxylic acid functional reactant, or a primary amine functional reactant. The di-hydroxyl functional reactant may comprise, for example, a bisphenol such as bisphenol A and/or bisphenol F. The di-carboxylic acid functional reactant may comprise, for example, a dimer fatty acid.

The mono-functional reactant may comprise a monophenol, a mono-functional acid, dimethylethanolamine, a monoepoxide such as the glycidyl ether of phenol, the glycidyl ether of nonylphenol, or the glycidyl ether of cresol, or any combination thereof.

The monophenol may comprise any suitable monophenol. For example, the monophenol may comprise phenol, 2-hydroxytoluene, 3-hydroxytoluene, 4-hydroxytoluene, 2-tert-butylphenol, 4-tert-butylphenol, 2-tert-butyl-4-methylphenol, 2-methoxyphenol, 4-methoxyphenol, 2-hydroxybenzyl alcohol, 4-hydroxybenzyl alcohol, nonylphenol, dodecylphenol, 1-hydroxynaphthalene, 2-hydroxynaphthalene, biphenyl-2-ol, biphenyl-4-ol and 2-allylphenol.

The mono-functional acid may comprise any compound or mixture of compounds having one carboxyl group per molecule. In addition to the carboxyl group, the mono-functional acid may comprise other functional groups that are not chemically reactive with epoxide, hydroxyl or carboxyl functional groups, and, therefore, do not interfere with the polymerization reaction. The mono-functional acid may comprise aromatic mono-acids such as benzoic acid or phenylalkanoic acids such as phenylacetic acid, 3-phenylpropanoic acid, and the like, and aliphatic mono-acids, as well as combinations thereof.

The ratio of functional groups from the di-functional chain extender and mono-functional reactant to the epoxide functional groups from the polyepoxide may be at least 0.50:1, such as at least 0.60:1, such as at least 0.65:1, such as at least 0.70:1. The ratio of functional groups from the di-functional chain extender and mono-functional reactant to the epoxide functional groups from the polyepoxide may be no more than 0.85:1, such as no more than such as no more than 0.80:1, such as no more than 0.75:1, such as no more than 0.70:1. The ratio of functional groups from the di-functional chain extender and mono-functional reactant to the epoxide functional groups from the polyepoxide may be 0.50:1 to 0.85:1, such as 0.50:1 to 0.80:1, such as 0.50:1 to 0.75:1, such as 0.50:1 to 0.70:1, such as 0.60:1 to 0.85:1, such as 0.60:1 to 0.80:1, such as 0.60:1 to 0.75:1, such as 0.60:1 to 0.70:1, such as 0.65:1 to 0.85:1, such as 0.65:1 to 0.80:1, such as 0.65:1 to 0.75:1, such as 0.65:1 to 0.70:1, such as 0.70:1 to 0.85:1, such as 0.70:1 to 0.80:1, such as 0.70:1 to 0.75:1.

The di-functional chain extender may comprise a di-hydroxyl functional reactant such as a bisphenol. The ratio of total phenolic hydroxyl groups from the bisphenol di-functional chain extender and functional groups from the mono-functional reactant to epoxide functional groups from the polyepoxide may be at least 0.50:1, such as at least 0.60:1, such as at least 0.65:1, such as at least 0.70:1. The ratio of total phenolic hydroxyl groups from the bisphenol di-functional chain extender and functional groups from the mono-functional reactant to epoxide functional groups from the polyepoxide may be no more than 0.85:1, such as no more than such as no more than 0.80:1, such as no more than 0.75:1, such as no more than 0.70:1. The ratio of total phenolic hydroxyl groups from the bisphenol di-functional chain extender and functional groups from the mono-functional reactant to epoxide functional groups from the polyepoxide may be 0.50:1 to 0.85:1, such as 0.50:1 to 0.80:1, such as 0.50:1 to 0.75:1, such as 0.50:1 to 0.70:1, such as 0.60:1 to 0.85:1, such as 0.60:1 to 0.80:1, such as 0.60:1 to 0.75:1, such as 0.60:1 to 0.70:1, such as 0.65:1 to 0.85:1, such as 0.65:1 to 0.80:1, such as 0.65:1 to 0.75:1, such as 0.65:1 to 0.70:1, such as 0.70:1 to 0.85:1, such as 0.70:1 to 0.80:1, such as 0.70:1 to 0.75:1.

The di-functional chain extender may comprise a di-hydroxyl functional reactant such as a bisphenol. The ratio of total phenolic hydroxyl groups from the bisphenol di-functional chain extender and acid groups from the mono-functional acid to epoxide functional groups from the polyepoxide may be at least 0.50:1, such as at least 0.60:1, such as at least 0.65:1, such as at least 0.70:1. The ratio of total phenolic hydroxyl groups from the bisphenol di-functional chain extender and acid groups from the mono-functional acid to epoxide functional groups from the polyepoxide may be no more than 0.85:1, such as no more than such as no more than 0.80:1, such as no more than 0.75:1, such as no more than 0.70:1. The ratio of total phenolic hydroxyl groups from the bisphenol di-functional chain extender and acid groups from the mono-functional acid to epoxide functional groups from the polyepoxide may be 0.50:1 to 0.85:1, such as 0.50:1 to 0.80:1, such as 0.50:1 to 0.75:1, such as 0.50:1 to 0.70:1, such as 0.60:1 to 0.85:1, such as 0.60:1 to 0.80:1, such as 0.60:1 to 0.75:1, such as 0.60:1 to 0.70:1, such as 0.65:1 to 0.85:1, such as 0.65:1 to 0.80:1, such as 0.65:1 to 0.75:1, such as 0.65:1 to 0.70:1, such as 0.70:1 to 0.85:1, such as 0.70:1 to 0.80:1, such as 0.70:1 to 0.75:1.

The di-functional chain extender may comprise a di-hydroxyl functional reactant such as a bisphenol. The ratio of total phenolic hydroxyl groups from the bisphenol di-functional chain extender and phenolic hydroxyl groups from the monophenol to epoxide functional groups from the polyepoxide may be at least 0.50:1, such as at least 0.60:1, such as at least 0.65:1, such as at least 0.70:1. The ratio of total phenolic hydroxyl groups from the bisphenol di-functional chain extender and phenolic hydroxyl groups from the monophenol to epoxide functional groups from the polyepoxide may be no more than 0.85:1, such as no more than such as no more than 0.80:1, such as no more than 0.75:1, such as no more than 0.70:1. The ratio of total phenolic hydroxyl groups from the bisphenol di-functional chain extender and phenolic hydroxyl groups from the monophenol to epoxide functional groups from the polyepoxide may be 0.50:1 to 0.85:1, such as 0.50:1 to 0.80:1, such as 0.50:1 to 0.75:1, such as 0.50:1 to 0.70:1, such as 0.60:1 to 0.85:1, such as 0.60:1 to 0.80:1, such as 0.60:1 to 0.75:1, such as 0.60:1 to 0.70:1, such as 0.65:1 to 0.85:1, such as 0.65:1 to 0.80:1, such as 0.65:1 to 0.75:1, such as 0.65:1 to 0.70:1, such as 0.70:1 to 0.85:1, such as 0.70:1 to 0.80:1, such as 0.70:1 to 0.75:1.

The di-functional chain extender may comprise a di-hydroxyl functional reactant such as a bisphenol. The ratio of phenolic hydroxyl functional groups from the bisphenol di-functional chain extender to phenolic hydroxyl functional groups from the monophenol and/or acid groups from the mono-functional acid may be at least 0.05:1, such as at least 0.1:1, such as at least 0.2:1, such as at least 0.3:1, such as at least 0.4:1, such as at least 0.5:1, such as at least 0.6:1, such as at least 0.7:1, such as at least 0.8:1. The ratio of phenolic hydroxyl functional groups from the bisphenol di-functional chain extender to phenolic hydroxyl functional groups from the monophenol may be no more than 9:1, such as no more than 4:1, such as no more than 2:1, such as no more than 1:1, such as no more than 0.8:1. The ratio of phenolic hydroxyl functional groups from the bisphenol di-functional chain extender to phenolic hydroxyl functional groups from the monophenol may be 0.05:1 to 9:1, such as 0.05:1 to 4:1, such as 0.05:1 to 2:1, such as 0.05:1 to 1:1, such as 0.05:1 to 0.8:1, such as 0.1:1 to 9:1, such as 0.1:1 to 4:1, such as 0.1:1 to 2:1, such as 0.1:1 to 1:1, such as 0.1:1 to 0.8:1, such as 0.2:1 to 9:1, such as 0.2:1 to 4:1, such as 0.2:1 to 2:1, such as 0.2:1 to 1:1, such as 0.2:1 to 0.8:1, such as 0.3:1 to 9:1, such as 0.3:1 to 4:1, such as 0.3:1 to 2:1, such as 0.3:1 to 1:1, such as 0.3:1 to 0.8:1, such as 0.4:1 to 9:1, such as 0.4:1 to 4:1, such as 0.4:1 to 2:1, such as 0.4:1 to 1:1, such as 0.4:1 to 0.8:1, such as 0.5:1 to 9:1, such as 0.5:1 to 4:1, such as 0.5:1 to 2:1, such as 0.5:1 to 1:1, such as 0.5:1 to 0.8:1, such as 0.6:1 to 9:1, such as 0.6:1 to 4:1, such as 0.6:1 to 2:1, such as 0.6:1 to 1:1, such as 0.6:1 to 0.8:1, such as 0.7:1 to 9:1, such as 0.7:1 to 4:1, such as 0.7:1 to 2:1, such as 0.7:1 to 1:1, such as 0.7:1 to 0.8:1, such as 0.8:1 to 9:1, such as 0.8:1 to 4:1, such as 0.8:1 to 2:1, such as 0.8:1 to 1:1.

The reaction product of a reaction mixture comprising (a) a polyepoxide; (b) di-functional chain extender; and (c) a mono-functional reactant may have an epoxy equivalent weight of at least 700 g/equivalent, such as at least 800 g/equivalent, such as at least 850 g/equivalent. The reaction product of a reaction mixture comprising (a) a polyepoxide; (b) di-functional chain extender; and (c) a mono-functional reactant may have an epoxy equivalent weight of no more than 1,500 g/equivalent, such as no more than 1,400 g/equivalent, such as no more than 1,200 g/equivalent, such as no more than 1,100 g/equivalent. The reaction product of a reaction mixture comprising (a) a polyepoxide; (b) di-functional chain extender; and (c) a mono-functional reactant may have an epoxy equivalent weight of 700 to 1,500 g/equivalent, such as 700 to 1,400 g/equivalent, such as 700 to 1,200 g/equivalent, such as 700 to 1,100 g/equivalent, such as 800 to 1,500 g/equivalent, such as 800 to 1,400 g/equivalent, such as 800 to 1,200 g/equivalent, such as 800 to 1,100 g/equivalent, such as 850 to 1,500 g/equivalent, such as 850 to 1,400 g/equivalent, such as 850 to 1,200 g/equivalent, such as 850 to 1,100 g/equivalent.

Cationic salt groups may be incorporated into the reaction product of a reaction mixture comprising (a) a polyepoxide; (b) di-functional chain extender; and (c) a mono-functional reactant as follows: The reaction product may be reacted with a cationic salt group former. By “cationic salt group former” is meant a material which is reactive with epoxy groups present and which may be acidified before, during, or after reaction with the epoxy groups on the reaction product to form cationic salt groups. Examples of suitable materials include amines such as primary or secondary amines which can be acidified after reaction with the epoxy groups to form amine salt groups, or tertiary amines which can be acidified prior to reaction with the epoxy groups and which after reaction with the epoxy groups form quaternary ammonium salt groups. Examples of other cationic salt group formers are sulfides which can be mixed with acid prior to reaction with the epoxy groups and form ternary sulfonium salt groups upon subsequent reaction with the epoxy groups.

Anionic salt groups may be incorporated into the reaction product of a reaction mixture comprising (a) a polyepoxide; (b) di-functional chain extender; and (c) a mono-functional reactant by reacting the reaction product with a polyprotic acid. Suitable polyprotic acids include, for example, an oxyacid of phosphorus, such as phosphoric acid and/or phosphonic acid.

The ionic salt group-containing film-forming polymer may comprise a cationic salt group containing film-forming polymer. The cationic salt group-containing film-forming polymer may be used in a cationic electrodepositable coating composition. As used herein, the term “cationic salt group-containing film-forming polymer” refers to polymers that include at least partially neutralized cationic groups, such as sulfonium groups and ammonium groups, that impart a positive charge. As used herein, the term “polymer” encompasses, but is not limited to, oligomers and both homopolymers and copolymers. The cationic salt group-containing film-forming polymer may comprise active hydrogen functional groups. As used herein, the term “active hydrogen functional groups” refers to those groups that are reactive with isocyanates as determined by the Zerewitinoff test as discussed above, and include, for example, hydroxyl groups, primary or secondary amine groups, and thiol groups. Cationic salt group-containing film-forming polymers that comprise active hydrogen functional groups may be referred to as active hydrogen-containing, cationic salt group-containing film-forming polymers.

Examples of polymers that are suitable for use as the cationic salt group-containing film-forming polymer in the present disclosure include, but are not limited to, alkyd polymers, acrylics, polyepoxides, polyamides, polyurethanes, polyureas, polyethers, and polyesters, among others.

More specific examples of suitable active hydrogen-containing, cationic salt group containing film-forming polymers include polyepoxide-amine adducts, such as the adduct of a polyglycidyl ethers of a polyphenol, such as Bisphenol A, and primary and/or secondary amines, such as are described in U.S. Pat. No. 4,031,050 at col. 3, line 27 to col. 5, line 50, U.S. Pat. No. 4,452,963 at col. 5, line 58 to col. 6, line 66, and U.S. Pat. No. 6,017,432 at col. 2, line 66 to col. 6, line 26, these portions of which being incorporated herein by reference. A portion of the amine that is reacted with the polyepoxide may be a ketimine of a polyamine, as is described in U.S. Pat. No. 4,104,147 at col. 6, line 23 to col. 7, line 23, the cited portion of which being incorporated herein by reference. Also suitable are ungelled polyepoxide-polyoxyalkylenepolyamine resins, such as are described in U.S. Pat. No. 4,432,850 at col. 2, line 60 to col. 5, line 58, the cited portion of which being incorporated herein by reference. In addition, cationic acrylic resins, such as those described in U.S. Pat. No. 3,455,806 at col. 2, line 18 to col. 3, line 61 and 3,928,157 at col. 2, line 29 to col. 3, line 21, these portions of both of which are incorporated herein by reference, may be used.

Besides amine salt group-containing resins, quaternary ammonium salt group-containing resins may also be employed as a cationic salt group-containing film-forming polymer in the present disclosure. Examples of these resins are those which are formed from reacting an organic polyepoxide with a tertiary amine acid salt. Such resins are described in U.S. Pat. No. 3,962,165 at col. 2, line 3 to col. 11, line 7; 3,975,346 at col. 1, line 62 to col. 17, line 25 and 4,001,156 at col. 1, line 37 to col. 16, line 7, these portions of which being incorporated herein by reference. Examples of other suitable cationic resins include ternary sulfonium salt group-containing resins, such as those described in U.S. Pat. No. 3,793,278 at col. 1, line 32 to col. 5, line 20, this portion of which being incorporated herein by reference. Also, cationic resins which cure via a transesterification mechanism, such as described in European Pat. Application No. 12463B1 at pg. 2, line 1 to pg. 6, line 25, this portion of which being incorporated herein by reference, may also be employed.

Other suitable cationic salt group-containing film-forming polymers include those that may form photodegradation resistant electrodepositable coating compositions. Such polymers include the polymers comprising cationic amine salt groups which are derived from pendant and/or terminal amino groups that are disclosed in U.S. Pat. Application Publication No. 2003/0054193 A1 at paragraphs [0064] to [0088], this portion of which being incorporated herein by reference. Also suitable are the active hydrogen-containing, cationic salt group-containing resins derived from a polyglycidyl ether of a polyhydric phenol that is essentially free of aliphatic carbon atoms to which are bonded more than one aromatic group, which are described in U.S. Pat. Application Publication No. 2003/0054193 A1 at paragraphs [0096] to [0123], this portion of which being incorporated herein by reference.

The active hydrogen-containing, cationic salt group-containing film-forming polymer is made cationic and water dispersible by at least partial neutralization with an acid. Suitable acids include organic and inorganic acids. Non-limiting examples of suitable organic acids include formic acid, acetic acid, methanesulfonic acid, and lactic acid. Non-limiting examples of suitable inorganic acids include phosphoric acid and sulfamic acid. By “sulfamic acid” is meant sulfamic acid itself or derivatives thereof such as those having the formula:

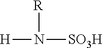

wherein R is hydrogen or an alkyl group having 1 to 4 carbon atoms. Mixtures of the above-mentioned acids also may be used in the present disclosure.

The extent of neutralization of the cationic salt group-containing film-forming polymer may vary with the particular polymer involved. However, sufficient acid should be used to sufficiently neutralize the cationic salt-group containing film-forming polymer such that the cationic salt-group containing film-forming polymer may be dispersed in an aqueous dispersing medium. For example, the amount of acid used may provide at least 20% of all of the total theoretical neutralization. Excess acid may also be used beyond the amount required for 100% total theoretical neutralization. For example, the amount of acid used to neutralize the cationic salt group-containing film-forming polymer may be ≥0.1% based on the total amines in the active hydrogen-containing, cationic salt group-containing film-forming polymer. Alternatively, the amount of acid used to neutralize the active hydrogen-containing, cationic salt group-containing film-forming polymer may be ≤100% based on the total amines in the active hydrogen-containing, cationic salt group-containing film-forming polymer. The total amount of acid used to neutralize the cationic salt group-containing film-forming polymer may range between any combination of values, which were recited in the preceding sentences, inclusive of the recited values. For example, the total amount of acid used to neutralize the active hydrogen-containing, cationic salt group-containing film-forming polymer may be 20%, 35%, 50%, 60%, or 80% based on the total amines in the cationic salt group-containing film-forming polymer.

The cationic salt group-containing film-forming polymer may be present in the cationic electrodepositable coating composition in an amount of at least 40% by weight, such as at least 50% by weight, such as at least 60% by weight, based on the total weight of the resin solids of the electrodepositable coating composition. The cationic salt group-containing film-forming polymer may be present in the cationic electrodepositable coating composition in an amount of no more than 90% by weight, such as no more than 80% by weight, such as no more than 75% by weight, based on the total weight of the resin solids of the electrodepositable coating composition. The cationic salt group-containing film-forming polymer may be present in the cationic electrodepositable coating composition in an amount of 40% to 90% by weight, such as 40% to 80% by weight, such as 40% to 75% by weight, such as 50% to 90% by weight, such as 50% to 80% by weight, such as 50% to 75% by weight, such as 60% to 90% by weight, such as 60% to 80% by weight, such as 60% to 75% by weight, based on the total weight of the resin solids of the electrodepositable coating composition.

As used herein, the “resin solids” include the ionic salt group-containing film-forming polymer, the curing agent, the addition polymer, and any additional water-dispersible non-pigmented component(s) present in the electrodepositable coating composition.

The ionic salt group containing film-forming polymer may comprise an anionic salt group containing film-forming polymer. As used herein, the term “anionic salt group containing film-forming polymer” refers to an anionic polymer comprising at least partially neutralized anionic functional groups, such as carboxylic acid and phosphoric acid groups that impart a negative charge. As used herein, the term “polymer” encompasses, but is not limited to, oligomers and both homopolymers and copolymers. The anionic salt group-containing film-forming polymer may comprise active hydrogen functional groups. As used herein, the term “active hydrogen functional groups” refers to those groups that are reactive with isocyanates as determined by the Zerewitinoff test as discussed above, and include, for example, hydroxyl groups, primary or secondary amine groups, and thiol groups. Anionic salt group-containing film-forming polymers that comprise active hydrogen functional groups may be referred to as active hydrogen-containing, anionic salt group-containing film-forming polymers. The anionic salt group containing film-forming polymer may be used in an anionic electrodepositable coating composition.

The anionic salt group-containing film-forming polymer may comprise base-solubilized, carboxylic acid group-containing film-forming polymers such as the reaction product or adduct of a drying oil or semi-drying fatty acid ester with a dicarboxylic acid or anhydride; and the reaction product of a fatty acid ester, unsaturated acid or anhydride and any additional unsaturated modifying materials which are further reacted with polyol. Also suitable are the at least partially neutralized interpolymers of hydroxy-alkyl esters of unsaturated carboxylic acids, unsaturated carboxylic acid and at least one other ethylenically unsaturated monomer. Still another suitable anionic electrodepositable resin comprises an alkyd-aminoplast vehicle, i.e., a vehicle containing an alkyd resin and an amine-aldehyde resin. Another suitable anionic electrodepositable resin composition comprises mixed esters of a resinous polyol. Other acid functional polymers may also be used such as phosphatized polyepoxide or phosphatized acrylic polymers. Exemplary phosphatized polyepoxides are disclosed in U.S. Pat. Application Publication No. 2009-0045071 at [0004]-[0015] and U.S. patent application Ser. No. 13/232,093 at [0014]-[0040], the cited portions of which being incorporated herein by reference. Also suitable are resins comprising one or more pendent carbamate functional groups, such as those described in U.S. Pat. No. 6,165,338.

The anionic salt group-containing film-forming polymer may be present in the anionic electrodepositable coating composition in an amount of at least 50% by weight, such as at least 55% by weight, such as at least 60% by weight, based on the total weight of the resin solids of the electrodepositable coating composition. The anionic salt group-containing film-forming polymer may be present in the anionic electrodepositable coating composition in an amount of no more than 90% by weight, such as no more than 80% by weight, such as no more than 75% by weight, based on the total weight of the resin solids of the electrodepositable coating composition. The anionic salt group-containing film-forming polymer may be present in the anionic electrodepositable coating composition in an amount 50% to 90%, such as 50% to 80% by weight, such as 50% to 75% by weight, such as 55% to 90% by weight, such as 55% to 80%, such as 55% to 75% by weight, such as 60% to 90% by weight, such as 60% to 80% by weight, such as 60% to 75%, based on the total weight of the resin solids of the electrodepositable coating composition.

The ionic salt group-containing film-forming polymer may be present in the electrodepositable coating composition in an amount of at least 40% by weight, such as at least 50% by weight, such as at least 55% by weight, such as at least 60% by weight, based on the total weight of the resin solids of the electrodepositable coating composition. The ionic salt group-containing film-forming polymer may be present in the electrodepositable coating composition in an amount of no more than 90% by weight, such as no more than 80% by weight, such as no more than 75% by weight, based on the total weight of the resin solids of the electrodepositable coating composition. The ionic salt group-containing film-forming polymer may be present in the electrodepositable coating composition in an amount of 40% to 90% by weight, such as 40% to 80% by weight, such as 40% to 75% by weight, such as 50% to 90% by weight, such as 50% to 80% by weight, such as 50% to 75% by weight, such as 55% to 90% by weight, such as 55% to 80% by weight, such as 55% to 75% by weight, such as 60% to 90% by weight, such as 60% to 80% by weight, such as 60% to 75% by weight, based on the total weight of the resin solids of the electrodepositable coating composition.

### Curing Agent

The electrodepositable coating composition of the present disclosure may further comprise a curing agent. The curing agent may be reactive with the ionic salt group-containing film-forming polymer. The curing agent may react with the reactive groups, such as active hydrogen groups, of the ionic salt group-containing film-forming polymer and the addition polymer to effectuate cure of the coating composition to form a coating. As used herein, the term “cure”, “cured” or similar terms, as used in connection with the electrodepositable coating compositions described herein, means that at least a portion of the components that form the electrodepositable coating composition are crosslinked to form a coating. Additionally, curing of the electrodepositable coating composition refers to subjecting said composition to curing conditions (e.g., elevated temperature) leading to the reaction of the reactive functional groups of the components of the electrodepositable coating composition, and resulting in the crosslinking of the components of the composition and formation of an at least partially cured coating. Non-limiting examples of suitable curing agents are at least partially blocked polyisocyanates, aminoplast resins and phenoplast resins, such as phenolformaldehyde condensates including allyl ether derivatives thereof.

Suitable at least partially blocked polyisocyanates include aliphatic polyisocyanates, aromatic polyisocyanates, and mixtures thereof. The curing agent may comprise an at least partially blocked aliphatic polyisocyanate. Suitable at least partially blocked aliphatic polyisocyanates include, for example, fully blocked aliphatic polyisocyanates, such as those described in U.S. Pat. No. 3,984,299 at col. 1 line 57 to col. 3 line 15, this portion of which is incorporated herein by reference, or partially blocked aliphatic polyisocyanates that are reacted with the polymer backbone, such as is described in U.S. Pat. No. 3,947,338 at col. 2 line 65 to col. 4 line 30, this portion of which is also incorporated herein by reference. By “blocked” is meant that the isocyanate groups have been reacted with a compound such that the resultant blocked isocyanate group is stable to active hydrogens at ambient temperature but reactive with active hydrogens in the film forming polymer at elevated temperatures, such as between 90° C. and 200° C. The polyisocyanate curing agent may be a fully blocked polyisocyanate with substantially no free isocyanate groups.

The polyisocyanate curing agent may comprise a diisocyanate, higher functional polyisocyanates or combinations thereof. For example, the polyisocyanate curing agent may comprise aliphatic and/or aromatic polyisocyanates. Aliphatic polyisocyanates may include (i) alkylene isocyanates, such as trimethylene diisocyanate, tetramethylene diisocyanate, pentamethylene diisocyanate, hexamethylene diisocyanate (“HDI”), 1,2-propylene diisocyanate, 1,2-butylene diisocyanate, 2,3-butylene diisocyanate, 1,3-butylene diisocyanate, ethylidene diisocyanate, and butylidene diisocyanate, and (ii) cycloalkylene isocyanates, such as 1,3-cyclopentane diisocyanate, 1,4-cyclohexane diisocyanate, 1,2-cyclohexane diisocyanate, isophorone diisocyanate, methylene bis(4-cyclohexylisocyanate) (“HMDI”), the cyclo-trimer of 1,6-hexmethylene diisocyanate (also known as the isocyanurate trimer of HDI, commercially available as Desmodur N3300 from Convestro AG), and meta-tetramethylxylylene diisocyanate (commercially available as TMXDI® from Allnex SA). Aromatic polyisocyanates may include (i) arylene isocyanates, such as m-phenylene diisocyanate, p-phenylene diisocyanate, 1,5-naphthalene diisocyanate and 1,4-naphthalene diisocyanate, and (ii) alkarylene isocyanates, such as 4,4′-diphenylene methane (“MDI”), 2,4-tolylene or 2,6-tolylene diisocyanate (“TDI”), or mixtures thereof, 4,4-toluidine diisocyanate and xylylene diisocyanate. Triisocyanates, such as triphenyl methane-4,4′,4″-triisocyanate, 1,3,5-triisocyanato benzene and 2,4,6-triisocyanato toluene, tetraisocyanates, such as 4,4′-diphenyldimethyl methane-2,2′,5,5′-tetraisocyanate, and polymerized polyisocyanates, such as tolylene diisocyanate dimers and trimers and the like, may also be used. The curing agent may comprise a blocked polyisocyanate selected from a polymeric polyisocyanate, such as polymeric HDI, polymeric MDI, polymeric isophorone diisocyanate, and the like. The curing agent may also comprise a blocked trimer of hexamethylene diisocyanate available as Desmodur N3300@ from Covestro AG. Mixtures of polyisocyanate curing agents may also be used.

The polyisocyanate curing agent may be at least partially blocked with at least one blocking agent selected from a 1,2-alkane diol, for example 1,2-propanediol; a 1,3-alkane diol, for example 1,3-butanediol; a benzylic alcohol, for example, benzyl alcohol; an allylic alcohol, for example, allyl alcohol; caprolactam; a dialkylamine, for example dibutylamine; and mixtures thereof. The polyisocyanate curing agent may be at least partially blocked with at least one 1,2-alkane diol having three or more carbon atoms, for example 1,2-butanediol.

Other suitable blocking agents include aliphatic, cycloaliphatic, or aromatic alkyl monoalcohols or phenolic compounds, including, for example, lower aliphatic alcohols, such as methanol, ethanol, and n-butanol; cycloaliphatic alcohols, such as cyclohexanol; aromatic-alkyl alcohols, such as phenyl carbinol and methylphenyl carbinol; and phenolic compounds, such as phenol itself and substituted phenols wherein the substituents do not affect coating operations, such as cresol and nitrophenol. Glycol ethers and glycol amines may also be used as blocking agents. Suitable glycol ethers include ethylene glycol butyl ether, diethylene glycol butyl ether, ethylene glycol methyl ether and propylene glycol methyl ether. Other suitable blocking agents include oximes, such as methyl ethyl ketoxime, acetone oxime and cyclohexanone oxime.

The curing agent may comprise an aminoplast resin. Aminoplast resins are condensation products of an aldehyde with an amino- or amido-group carrying substance. Condensation products obtained from the reaction of alcohols and an aldehyde with melamine, urea or benzoguanamine may be used. However, condensation products of other amines and amides may also be employed, for example, aldehyde condensates of triazines, diazines, triazoles, guanidines, guanamines and alkyl- and aryl-substituted derivatives of such compounds, including alkyl- and aryl-substituted ureas and alkyl- and aryl-substituted melamines. Some examples of such compounds are N,N′-dimethyl urea, benzourea, dicyandiamide, formaguanamine, acetoguanamine, ammeline, 2-chloro-4,6-diamino-1,3,5-triazine, 6-methyl-2,4-diamino-1,3,5-triazine, 3,5-diaminotriazole, triaminopyrimidine, 2-mercapto-4,6-diaminopyrimidine, 3,4,6-tris(ethylamino)-1,3,5-triazine, and the like. Suitable aldehydes include formaldehyde, acetaldehyde, crotonaldehyde, acrolein, benzaldehyde, furfural, glyoxal and the like.

The aminoplast resins may contain methylol or similar alkylol groups, and at least a portion of these alkylol groups may be etherified by a reaction with an alcohol to provide organic solvent-soluble resins. Any monohydric alcohol may be employed for this purpose, including such alcohols as methanol, ethanol, propanol, butanol, pentanol, hexanol, heptanol and others, as well as benzyl alcohol and other aromatic alcohols, cyclic alcohol such as cyclohexanol, monoethers of glycols such as Cello solves and Carbitols, and halogen-substituted or other substituted alcohols, such as 3-chloropropanol and butoxyethanol.

Non-limiting examples of commercially available aminoplast resins are those available under the trademark CYMEL® from Allnex Belgium SA/NV, such as CYMEL 1130 and 1156, and RESIMENE® from INEOS Melamines, such as RESIMENE 750 and 753. Examples of suitable aminoplast resins also include those described in U.S. Pat. No. 3,937,679 at col. 16, line 3 to col. 17, line 47, this portion of which being hereby incorporated by reference. As is disclosed in the aforementioned portion of the '679 patent, the aminoplast may be used in combination with the methylol phenol ethers.

Phenoplast resins are formed by the condensation of an aldehyde and a phenol. Suitable aldehydes include formaldehyde and acetaldehyde. Methylene-releasing and aldehyde-releasing agents, such as paraformaldehyde and hexamethylene tetramine, may also be utilized as the aldehyde agent. Various phenols may be used, such as phenol itself, a cresol, or a substituted phenol in which a hydrocarbon radical having either a straight chain, a branched chain or a cyclic structure is substituted for a hydrogen in the aromatic ring. Mixtures of phenols may also be employed. Some specific examples of suitable phenols are p-phenylphenol, p-tert-butylphenol, p-tert-amylphenol, cyclopentylphenol and unsaturated hydrocarbon-substituted phenols, such as the monobutenyl phenols containing a butenyl group in ortho, meta or para position, and where the double bond occurs in various positions in the hydrocarbon chain.

Aminoplast and phenoplast resins, as described above, are described in U.S. Pat. No. 4,812,215 at co1.6, line 20 to col. 7, line 12, the cited portion of which being incorporated herein by reference.

The curing agent may be present in the cationic electrodepositable coating composition in an amount of at least 10% by weight, such as at least 20% by weight, such as at least 25% by weight, based on the total weight of the resin solids of the electrodepositable coating composition. The curing agent may be present in the cationic electrodepositable coating composition in an amount of no more than 60% by weight, such as no more than 50% by weight, such as no more than 40% by weight, based on the total weight of the resin solids of the electrodepositable coating composition. The curing agent may be present in the cationic electrodepositable coating composition in an amount of 10% to 60% by weight, such as 10% to 50% by weight, such as 10% to 40% by weight, such as 20% to 60% by weight, such as 20% to 50% by weight, such as 20% to 40% by weight, such as 25% to 60% by weight, such as 25% to 50% by weight, such as 25% to 40% by weight, based on the total weight of the resin solids of the electrodepositable coating composition.

The curing agent may be present in the anionic electrodepositable coating composition in an amount of at least 10% by weight, such as at least 20% by weight, such as at least 25% by weight, based on the total weight of the resin solids of the electrodepositable coating composition. The curing agent may be present in the anionic electrodepositable coating composition in an amount of no more than 50% by weight, such as no more than 45% by weight, such as no more than 40% by weight, based on the total weight of the resin solids of the electrodepositable coating composition. The curing agent may be present in the anionic electrodepositable coating composition in an amount of 10% to 50% by weight, such as 10% to 45% by weight, such as 10% to 40% by weight, such as 20% to 50% by weight, such as 20% to 45% by weight, such as 20% to 40% by weight, such as 25% to 50% by weight, such as 25% to 45% by weight, such as 25% to 40% by weight, based on the total weight of the resin solids of the electrodepositable coating composition.

The curing agent may be present in the electrodepositable coating composition in an amount of at least 10% by weight, such as at least 20% by weight, such as at least 25% by weight, based on the total weight of the resin solids of the electrodepositable coating composition. The curing agent may be present in the electrodepositable coating composition in an amount of no more than 60% by weight, such as no more than 50% by weight, such as no more than 45% by weight, such as no more than 40% by weight, based on the total weight of the resin solids of the electrodepositable coating composition. The curing agent may be present in the electrodepositable coating composition in an amount of 10% to 60% by weight, such as 10% to 50% by weight, such as 10% to 45% by weight, such as 10% to 40% by weight, such as 20% to 60% by weight, such as 20% to 50% by weight, such as 20% to 45% by weight, such as 20% to 40% by weight, such as 25% to 60% by weight, such as 25% to 50% by weight, such as 25% to 45% by weight, such as 25% to 40% by weight, based on the total weight of the resin solids of the electrodepositable coating composition.

### Amine-Containing Curing Catalyst and/or Zinc-Containing Curing Catalyst

The electrodepositable coating composition further comprises an amine-containing curing catalyst and/or a zinc-containing curing catalyst.

The amine-containing curing catalyst may comprise any suitable amine-containing curing catalyst. For example, the amine-containing curing catalyst may comprise a guanidine curing catalyst, an imidazole curing catalyst, an amidine, or any combination thereof.

It will be understood that “guanidine,” as used herein, refers to guanidine and derivatives thereof. For example, the guanidine may comprise a compound, moiety, and/or residue having the following general structure:

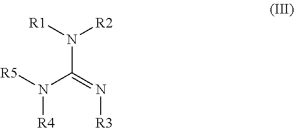

wherein each of R1, R2, R3, R4, and R5 (i.e., substituents of structure (III)) comprise hydrogen, (cyclo)alkyl, aryl, aromatic, organometallic, a polymeric structure, or together can form a cycloalkyl, aryl, or an aromatic structure, and wherein R1, R2, R3, R4, and R5 may be the same or different. As used herein, “(cyclo)alkyl” refers to both alkyl and cycloalkyl. When any of the R groups “together can form a (cyclo)alkyl, aryl, and/or aromatic group” it is meant that any two adjacent R groups are connected to form a cyclic moiety, such as the rings in structures (IV)-(VII) below.

It will be appreciated that the double bond between the carbon atom and the nitrogen atom that is depicted in structure (III) may be located between the carbon atom and another nitrogen atom of structure (III). Accordingly, the various substituents of structure (III) may be attached to different nitrogen atoms depending on where the double bond is located within the structure.

The guanidine may comprise a cyclic guanidine such as a guanidine of structure (III) wherein two or more R groups of structure (III) together form one or more rings. In other words, the cyclic guanidine may comprise ≥1 ring(s). For example, the cyclic guanidine may either be a monocyclic guanidine (1 ring) such as depicted in structures (IV) and (V) below, or the cyclic guanidine may be bicyclic or polycyclic guanidine (≥2 rings) such as depicted in structures (VI) and (VII) below.

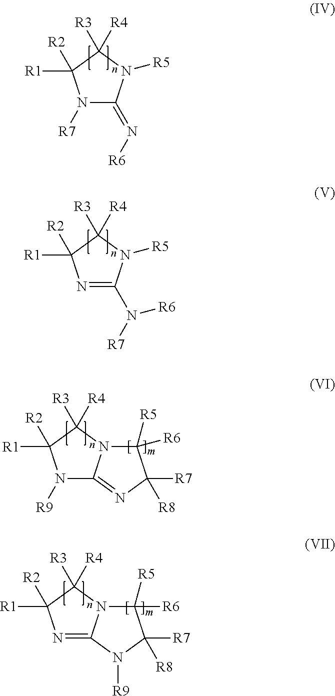

Each substituent of structures (IV) and/or (V), R1-R7, may comprise hydrogen, (cyclo)alkyl, aryl, aromatic, organometallic, a polymeric structure, or together can form a cycloalkyl, aryl, or an aromatic structure, and wherein R1-R7 may be the same or different. Similarly, each substituent of structures (VI) and (VII), R1-R9, may be hydrogen, alkyl, aryl, aromatic, organometallic, a polymeric structure, or together can form a cycloalkyl, aryl, or an aromatic structure, and wherein R1-R9 may be the same or different. Moreover, in some examples of structures (IV) and/or (V), certain combinations of R1-R7 may be part of the same ring structure. For example, R1 and R7 of structure (IV) may form part of a single ring structure. Moreover, it will be understood that any combination of substituents (R1-R7 of structures (IV) and/or (V) as well as R1-R9 of structures (VI) and/or (VII)) may be chosen so long as the substituents do not substantially interfere with the catalytic activity of the cyclic guanidine.

Each ring in the cyclic guanidine may be comprised of ≥5 members. For example, the cyclic guanidine may comprise a 5-member ring, a 6-member ring, and/or a 7-member ring. As used herein, the term “member” refers to an atom located in a ring structure. Accordingly, a 5-member ring will have 5 atoms in the ring structure (“n” and/or “m”=1 in structures (IV)-(VII)), a 6-member ring will have 6 atoms in the ring structure (“n” and/or “m”=2 in structures (IV)-(VII)), and a 7-member ring will have 7 atoms in the ring structure (“n” and/or “m”=3 in structures (IV)-(VII)). It will be appreciated that if the cyclic guanidine is comprised of ≥2 rings (e.g., structures (VI) and (VII)), the number of members in each ring of the cyclic guanidine can either be the same or different. For example, one ring may be a five-member ring while the other ring may be a six-member ring. If the cyclic guanidine is comprised of ≥3 rings, then in addition to the combinations cited in the preceding sentence, the number of members in a first ring of the cyclic guanidine may be different from the number of members in any other ring of the cyclic guanidine.

It will also be understood that the nitrogen atoms of structures (IV)-(VII) may further have additional atoms attached thereto. Moreover, the cyclic guanidine may either be substituted or unsubstituted. For example, as used herein in conjunction with the cyclic guanidine, the term “substituted” refers to a cyclic guanidine wherein R5, R6, and/or R7 of structures (IV) and/or (V) and/or R9 of structures (VI) and/or (VII) is not hydrogen. As used herein in conjunction with the cyclic guanidine, the term “unsubstituted” refers to a cyclic guanidine wherein R1-R7 of structures (IV) and/or (V) and/or R1-R9 of structures (VI) and/or (VII) are hydrogen.

The cyclic guanidine may comprise a bicyclic guanidine, and the bicyclic guanidine may comprise 1,5,7-triazabicyclo[4.4.0]dec-5-ene (“TBD” or “BCG”).

The guanidine may be reacted with an epoxy compound to form a guanidine reaction product for use as curing catalyst. The epoxy compound may be a polyepoxide having at least two 1,2-epoxy groups. The epoxy compound may be saturated or unsaturated, cyclic or acyclic, aliphatic, alicyclic, aromatic or heterocyclic. Moreover, the epoxy compound may contain substituents such as halogen, hydroxyl, and ether groups.

Examples of polyepoxides are those having a 1,2-epoxy equivalency greater than one and/or two; that is, polyepoxides which have on average two or more epoxide groups per molecule. Suitable polyepoxides include polyglycidyl ethers of polyhydric alcohols such as cyclic polyols and polyglycidyl ethers of polyhydric phenols such as Bisphenol A. These polyepoxides may be produced by etherification of polyhydric phenols with an epihalohydrin or dihalohydrin such as epichlorohydrin or dichlorohydrin in the presence of alkali. Besides polyhydric phenols, other cyclic polyols may be used in preparing the polyglycidyl ethers of cyclic polyols. Examples of other cyclic polyols include alicyclic polyols, including cycloaliphatic polyols such as hydrogenated bisphenol A, 1,2-cyclohexane diol and 1,2-bis(hydroxymethyl)cyclohexane.

The polyepoxides may have epoxide equivalent weights of ≥180 g/epoxide group. The polyepoxides may have epoxide equivalent weights of ≤2,000 g/epoxide group. The polyepoxides may have epoxide equivalent weights that range between any combination of values, which were recited in the preceding sentences, inclusive of the recited values. For example, the polyepoxides may have epoxide equivalent weights from 186 to 1,200 g/epoxide group.

The guanidine or guanidine reaction product described above may be at least partially neutralized with an acid (acidified). Suitable acids include organic and inorganic acids. Non-limiting examples of suitable organic acids include formic acid, acetic acid, methanesulfonic acid, and lactic acid. Non-limiting examples of suitable inorganic acids include phosphoric acid and sulfamic acid. Mixtures of the above-mentioned acids also may be used in the present disclosure.

The extent of neutralization of the guanidine or guanidine reaction product varies with the particular guanidine or guanidine reaction product involved. However, sufficient acid should be used to disperse the guanidine or guanidine reaction product in water. Typically, the amount of acid used provides at least 20% of all of the total neutralization. Excess acid may also be used beyond the amount required for 100% total neutralization. For example, the amount of acid used to neutralize the guanidine or guanidine reaction product may be ≥0.1% based on the total amines in the guanidine or guanidine reaction product. Additionally, the amount of acid used to neutralize the guanidine or guanidine reaction product may be ≤100% based on the total amines in the guanidine or guanidine reaction product. The total amount of acid used to neutralize the guanidine or guanidine reaction product may range between any combination of values, which were recited in the preceding sentences, inclusive of the recited values. For example, the total amount of acid used to neutralize the guanidine or guanidine reaction product may be 20%, 35%, 50%, 60% or 80% based on the total amines in the guanidine or guanidine reaction product.

The imidazole curing catalyst may comprise the imidazole modified product as described in Int'l Pub. No. WO 2020/203311 A1.

The amidine curing catalyst may comprise 1,8-diazabicyclo[5.4.0]undec-7-ene (DBU).

The amine-containing curing catalyst may be present in the coating composition in an amount of at least 0.1% by weight, based on the total weight of the resin solids of the coating composition, such as at least 0.2% by weight, such as at least 0.5% by weight, such as at least 0.8% by weight, such as at least 1% by weight, such as at least 1.5% by weight. The amine-containing curing catalyst may be present in the coating composition in an amount of no more than 7% by weight, based on the total weight of the resin solids of the coating composition, such as no more than 4% by weight, such as no more than 2% by weight, such as no more than 1.5% by weight, such as no more than 1% by weight. The amine-containing curing catalyst may be present in the coating composition in an amount of 0.1% to 7% by weight, based on the total weight of the resin solids of the coating composition, such as 0.1% to 4% by weight, such as 0.1% to 2% by weight, such as 0.1% to 1.5% by weight, such as 0.1% to 1% by weight, such as 0.2% to 7% by weight, such as 0.2% to 4% by weight, such as 0.2% to 2% by weight, such as 0.2% to 1.5% by weight, such as 0.2% to 1% by weight, such as 0.5% to 7% by weight, such as 0.5% to 4% by weight, such as 0.5% to 2% by weight, such as 0.5% to 1.5% by weight, such as 0.5% to 1% by weight, such as 0.8% to 7% by weight, such as 0.8% to 4% by weight, such as 0.8% to 2% by weight, such as 0.8% to 1.5% by weight, such as 0.8% to 1% by weight, such as 1% to 7% by weight, such as 1% to 4% by weight, such as 1% to 2% by weight, such as 1% to 1.5% by weight, such as 1.5% to 7% by weight, such as 1.5% to 4% by weight, such as 1.5% to 2% by weight.

The zinc-containing catalyst may comprise a metal salt and/or complex of zinc. For example, the zinc-containing curing catalyst may comprise a zinc (II) amidine complex, zinc octoate, zinc naphthenate, zinc tallate, zinc carboxylates having from about 8 to 14 carbons in the carboxylate group, zinc acetate, zinc sulfonates, zinc methanesulfonates, or any combination thereof.

The zinc (II) amidine complex contains amidine and carboxylate ligands. More specifically, the zinc (II) amidine complex comprises compounds having the formula Zn(A)₂(C)₂ wherein A represents an amidine and C represents a carboxylate. More specifically, A may be represented by the formula (1) or (2):

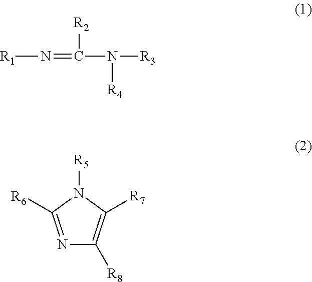

wherein R¹ and R³ are each independently hydrogen or an organic group attached through a carbon atom or are joined to one another by an N═C—N linkage to form a heterocyclic ring with one or more hetero atoms or a fused bicyclic ring with one or more heteroatoms; R² is hydrogen, an organic group attached through a carbon atom, an amine group which is optionally substituted, or a hydroxyl group which is optionally etherified with a hydrocarbyl group having up to 8 carbon atoms; R⁴ is hydrogen, an organic group attached through a carbon atom or a hydroxyl group which can be optionally etherified with a hydrocarbyl group having up to 8 carbon atoms; and R⁵, R⁶, R⁷ and R⁸ are independently hydrogen, alkyl substituted alkyl hydroxyalkyl, aryl, aralkyl, cycloalkyl, heterocyclics, ether, thioether, halogen, —N(R)₂, polyethylene polyamines, nitro groups, keto groups, ester groups, or carbonamide groups optionally alkyl substituted with alkyl substituted alkyl hydroxyalkyl, aryl, aralkyl, cycloalkyl, heterocycles, ether, thioether, halogen, —N(R)₂, polyethylene polyamines, nitro groups, keto groups or ester groups; and C is an aliphatic, aromatic or polymeric carboxylate with an equivalent weight of 45 to 465.

The zinc-containing curing catalyst may be present in the coating composition in an amount of at least 0.1% by weight, based on the total weight of the resin solids of the coating composition, such as at least 0.2% by weight, such as at least 0.5% by weight, such as at least 0.8% by weight, such as at least 1% by weight, such as at least 1.5% by weight. The zinc-containing curing catalyst may be present in the coating composition in an amount of no more than 7% by weight, based on the total weight of the resin solids of the coating composition, such as no more than 4% by weight, such as no more than 2% by weight, such as no more than 1.5% by weight, such as no more than 1% by weight. The zinc-containing curing catalyst may be present in the coating composition in an amount of 0.1% to 7% by weight, based on the total weight of the resin solids of the coating composition, such as 0.1% to 4% by weight, such as 0.1% to 2% by weight, such as 0.1% to 1.5% by weight, such as 0.1% to 1% by weight, such as 0.2% to 7% by weight, such as 0.2% to 4% by weight, such as 0.2% to 2% by weight, such as 0.2% to 1.5% by weight, such as 0.2% to 1% by weight, such as 0.5% to 7% by weight, such as 0.5% to 4% by weight, such as 0.5% to 2% by weight, such as 0.5% to 1.5% by weight, such as 0.5% to 1% by weight, such as 0.8% to 7% by weight, such as 0.8% to 4% by weight, such as 0.8% to 2% by weight, such as 0.8% to 1.5% by weight, such as 0.8% to 1% by weight, such as 1% to 7% by weight, such as 1% to 4% by weight, such as 1% to 2% by weight, such as 1% to 1.5% by weight, such as 1.5% to 7% by weight, such as 1.5% to 4% by weight, such as 1.5% to 2% by weight.

### Further Components of the Electrodepositable Coating Compositions

The electrodepositable coating composition may optionally comprise one or more further components in addition to the hydroxyl-functional addition polymer, the ionic salt group-containing film-forming polymer, the curing agent, and the amine-containing curing catalyst and/or zinc-containing curing catalyst described above.

The electrodepositable coating compositions of the present disclosure may optionally comprise a corrosion inhibitor. Any suitable corrosion inhibitor may be used. For example, the corrosion inhibitor may comprise a corrosion inhibitor comprising yttrium, lanthanum, cerium, calcium, an azole, or any combination thereof.

Non-limiting examples of suitable azoles include benzotriazole, 5-methyl benzotriazole, 2-amino thiazole, as well as salts thereof.

The corrosion inhibitor(s) may be present, if at all, in the electrodepositable coating composition in an amount of at least 0.001% by weight, such as at least 5% by weight, based on the total weight of the electrodepositable coating composition. The corrosion inhibitor(s) may be present, if at all, in the electrodepositable coating composition in an amount of no more than 25% by weight, such as no more than 15% by weight, such as no more than 10% by weight, based on the total weight of the electrodepositable coating composition. The corrosion inhibitor(s) may be present, if at all, in the electrodepositable coating composition in an amount of 0.001% to 25% by weight, such as 0.001% to 15% by weight, such as 0.001% to 10% by weight, such as 5% to 25% by weight, such as 5% to 15% by weight, such as 5% to 10% by weight, based on the total weight of the electrodepositable coating composition.

Alternatively, the electrodepositable coating composition may be substantially free, essentially free, or completely free of a corrosion inhibitor.

The electrodepositable coating composition may optionally further comprise a silane. The silane may comprise a functional group such as, for example, hydroxyl, carbamate, epoxy, isocyanate, amine, amine-salt, mercaptan, or combinations thereof. The silane may comprise, for example, an aminosilane, a mercaptosilane, or combinations thereof. Mixtures of an aminosilane and a silane having an unsaturated group, such as vinyltriacetoxysilane, may also be used.

The silane may be present, if at all, in the electrodepositable coating composition in an amount of at least 0.01% by weight, such as at least 0.1% by weight, such as at least 1% by weight, such as at least 3% by weight, based on the total weight of the resin solids. The silane may be present, if at all, in the electrodepositable coating composition in an amount of no more than 5% by weight, such as no more than 3% by weight, such as no more than 1% by weight, based on the total weight of the resin solids. The silane may be present, if at all, in the electrodepositable coating composition in an amount of 0.01% to 5% by weight, such as 0.01% to 3% by weight, such as 0.01% to 1% by weight, such as 0.1% to 5% by weight, such as 0.01% to 3% by weight, such as 0.1% to 1% by weight, such as 1% to 5% by weight, such as 1% to 3% by weight, such as 3% to 5% by weight, based on the total weight of the resin solids.

Alternatively, the electrodepositable coating composition may be substantially free, essentially free, or completely free of a silane.

The electrodepositable coating composition may optionally further comprise a pigment. The pigment may comprise an iron oxide, a lead oxide, strontium chromate, carbon black, coal dust, titanium dioxide, barium sulfate, a color pigment, a phyllosilicate pigment, a metal pigment, a thermally conductive, electrically insulative filler, fire-retardant pigment, or any combination thereof.

The pigment-to-binder (P:B) ratio as set forth in this disclosure may refer to the weight ratio of the pigment-to-binder in the electrodepositable coating composition, and/or the weight ratio of the pigment-to-binder in the deposited wet film, and/or the weight ratio of the pigment to the binder in the dry, uncured deposited film, and/or the weight ratio of the pigment-to-binder in the cured film. The pigment-to-binder (P:B) ratio of the pigment to the electrodepositable binder may be at least 0.05:1, such as at least 0.1:1, such as at least 0.2:1, such as at least 0.30:1, such as at least 0.35:1, such as at least 0.40:1, such as at least 0.50:1, such as at least 0.60:1, such as at least 0.75:1, such as at least 1:1, such as at least 1.25:1, such as at least 1.5:1. The pigment-to-binder (P:B) ratio of the pigment to the electrodepositable binder may be no more than 2.0:1, such as no more than 1.75:1, such no more than 1.5:1, such as no more than 1.25:1, such as no more than 1:1, such as no more than 0.75:1, such as no more than 0.70:1, such as no more than 0.60:1, such as no more than 0.55:1, such as no more than 0.50:1, such as no more than 0.30:1, such as no more than 0.20:1, such as no more than 0.10:1. The pigment-to-binder (P:B) ratio of the pigment to the electrodepositable binder may be 0.05:1 to 2.0:1, such as 0.05:1 to 1.75:1, such as 0.05:1 to 1.50:1, such as 0.05:1 to 1.25:1, such as 0.05:1 to 1:1, such as 0.05:1 to 0.75:1, such as 0.05:1 to 0.70:1, such as 0.05:1 to 0.60:1, such as 0.05:1 to 0.55:1, such as 0.05:1 to 0.50:1, such as 0.05:1 to 0.30:1, such as 0.05:1 to 0.20:1, such as 0.05:1 to 0.10:1, such as 0.1:1 to 2.0:1, such as 0.1:1 to 1.75:1, such as 0.1:1 to 1.50:1, such as 0.1:1 to 1.25:1, such as 0.1:1 to 1:1, such as 0.1:1 to 0.75:1, such as 0.1:1 to 0.70:1, such as 0.1:1 to 0.60:1, such as 0.1:1 to 0.55:1, such as 0.1:1 to 0.50:1, such as 0.1:1 to 0.30:1, such as 0.1:1 to 0.20:1, such as 0.2:1 to 2.0:1, such as 0.2:1 to 1.75:1, such as 0.2:1 to 1.50:1, such as 0.2:1 to 1.25:1, such as 0.2:1 to 1:1, such as 0.2:1 to 0.75:1, such as 0.2:1 to 0.70:1, such as 0.2:1 to 0.60:1, such as 0.2:1 to 0.55:1, such as 0.2:1 to 0.50:1, such as 0.2:1 to 0.30:1, such as 0.3:1 to 2.0:1, such as 0.3:1 to 1.75:1, such as 0.3:1 to 1.50:1, such as 0.3:1 to 1.25:1, such as 0.3:1 to 1:1, such as 0.3:1 to 0.75:1, such as 0.3:1 to 0.70:1, such as 0.3:1 to 0.60:1, such as 0.3:1 to 0.55:1, such as 0.3:1 to 0.50:1, such as 0.3:1 to 0.30:1, such as 0.35:1 to 2.0:1, such as 0.35:1 to 1.75:1, such as 0.35:1 to 1.50:1, such as 0.35:1 to 1.25:1, such as 0.35:1 to 1:1, such as 0.35:1 to 0.75:1, such as 0.35:1 to 0.70:1, such as 0.35:1 to 0.60:1, such as 0.35:1 to 0.55:1, such as 0.35:1 to 0.50:1, such as 0.4:1 to 2.0:1, such as 0.4:1 to 1.75:1, such as 0.4:1 to 1.50:1, such as 0.4:1 to 1.25:1, such as 0.4:1 to 1:1, such as 0.4:1 to 0.75:1, such as 0.4:1 to 0.70:1, such as 0.4:1 to 0.60:1, such as 0.4:1 to 0.55:1, such as 0.4:1 to 0.50:1, such as 0.5:1 to 2.0:1, such as 0.5:1 to 1.75:1, such as 0.5:1 to 1.50:1, such as 0.5:1 to 1.25:1, such as 0.5:1 to 1:1, such as 0.5:1 to 0.75:1, such as 0.5:1 to 0.70:1, such as 0.5:1 to 0.60:1, such as 0.5:1 to 0.55:1, such as 0.6:1 to 2.0:1, such as 0.6:1 to 1.75:1, such as 0.6:1 to 1.50:1, such as 0.6:1 to 1.25:1, such as 0.6:1 to 1:1, such as 0.6:1 to 0.75:1, such as 0.6:1 to 0.70:1, such as 0.75:1 to 2.0:1, such as 0.75:1 to 1.75:1, such as 0.75:1 to 1.50:1, such as 0.75:1 to 1.25:1, such as 0.75:1 to 1:1, such as 1:1 to 2.0:1, such as 1:1 to 1.75:1, such as 1:1 to 1.50:1, such as 1:1 to 1.25:1, such as 1.25:1 to 2.0:1, such as 1.25:1 to 1.75:1, such as 1.25:1 to 1.50:1, such as 1.50:1 to 2.0:1, such as 1.50:1 to 1.75:1.

The electrodepositable coating composition may optionally further comprise a bismuth catalyst. As used herein, the term “bismuth catalyst” refers to catalysts that contain bismuth and catalyze transurethanation reactions, and specifically catalyze the deblocking of the blocked polyisocyanate curing agent blocking groups.

The bismuth catalyst may comprise a soluble bismuth catalyst. As used herein, a “soluble” or “solubilized” bismuth catalyst is at catalyst wherein at least 35% of the bismuth catalyst dissolves in an aqueous medium having a pH in the range of 4 to 7 at room temperature (e.g., 23° C.). The soluble bismuth catalyst may provide solubilized bismuth metal in an amount of at least 0.04% by weight, based on the total weight of the electrodepositable coating composition.

Alternatively, the bismuth catalyst may comprise an insoluble bismuth catalyst. As used herein, an “insoluble” bismuth catalyst is at catalyst wherein less than 35% of the catalyst dissolves in an aqueous medium having a pH in the range of 4 to 7 at room temperature (e.g., 23° C.). The insoluble bismuth catalyst may provide solubilized bismuth metal in an amount of less than 0.04% by weight, based on the total weight of the electrodepositable coating composition.

The percentage of solubilized bismuth catalyst present in the composition may be determined using ICP-MS to calculate the total amount of bismuth metal (i.e., soluble and insoluble) and total amount of solubilized bismuth metal and calculating the percentage using those measurements.

The bismuth catalyst may comprise a bismuth compound and/or complex.

The bismuth catalyst may, for example, comprise a colloidal bismuth oxide or bismuth hydroxide, a bismuth compound complex such as, for example, a bismuth chelate complex, or a bismuth salt of an inorganic or organic acid, wherein the term “bismuth salt” includes not only salts comprising bismuth cations and acid anions, but also bismuthoxy salts.

Examples of inorganic or organic acids from which the bismuth salts may be derived are hydrochloric acid, sulphuric acid, nitric acid, inorganic or organic sulphonic acids, carboxylic acids, for example, formic acid or acetic acid, amino carboxylic acids and hydroxy carboxylic acids, such as lactic acid or dimethylolpropionic acid.

Non-limiting examples of bismuth salts are aliphatic hydroxycarboxylic acid salts of bismuth, such as lactic acid salts or dimethylolpropionic acid salts of bismuth, for example, bismuth lactate or bismuth dimethylolpropionate; bismuth subnitrate; amidosulphonic acid salts of bismuth; hydrocarbylsulphonic acid salts of bismuth, such as alkyl sulphonic acid salts, including methane sulphonic acid salts of bismuth, for example, bismuth methane sulphonate. Further non-limiting examples of bismuth compound or complex catalysts include bismuth oxides, bismuth carboxylates, bismuth sulfamate, bismuth sulphonate, and combinations thereof.

The bismuth catalyst may be present in an amount of at least 0.01% by weight of bismuth metal, such as at least 0.1% by weight, such as at least 0.2% by weight, such as at least 0.5% by weight, such as at least 1% by weight, such as 1% by weight, based on the total resin solids weight of the composition. The bismuth catalyst may be present in an amount of no more than 3% by weight of bismuth metal, such as no more than 1.5% by weight, such as no more than 1% by weight, based on the total resin solids weight of the composition. The bismuth catalyst may be present in an amount of 0.01% to 3% by weight of bismuth metal, such as 0.1% to 1.5% by weight, such as 0.2% to 1% by weight, such as 0.5% to 3% by weight, such as 0.5% to 1.5% by weight, such as 0.5% to 1% by weight, such as 1% to 3% by weight, such as 1% to 1.5% by weight, based on the total resin solids weight of the composition.

The bismuth catalyst may be present in an amount such that the amount of solubilized bismuth metal may be at least 0.04% by weight, based on the total weight of the electrodepositable coating composition, such as at least 0.06% by weight, such as at least 0.07% by weight, such as at least 0.08% by weight, such as at least 0.09% by weight, such as at least 0.10% by weight, such as at least 0.11% by weight, such as at least 0.12% by weight, such as at least 0.13% by weight, such as at least 0.14% by weight, or higher. The bismuth catalyst may be present in an amount such that the amount of solubilized bismuth metal of no more than 0.30% by weight, based on the total weight of the electrodepositable coating composition.

The bismuth catalyst may be present in an amount such that the amount of solubilized bismuth metal may be at least 0.22% by weight, based on the total weight of the resin solids, such as at least 0.30% by weight, such as at least 0.34% by weight, such at least 0.40% by weight, such as at least 0.45% by weight, such as 0.51% by weight, such as at least 0.56% by weight, such as at least 0.62% by weight, such as at least 0.68% by weight, such as at least 0.73% by weight, such as at least 0.80% by weight, or higher.

The electrodepositable coating composition may be substantially free, essentially free, or completely free of bismuth subnitrate. As used herein, an electrodepositable coating composition is “substantially free” of bismuth subnitrate if bismuth subnitrate is present, if at all, in an amount less than 0.01% by weight, based on the total resin solids weight of the composition. As used herein, an electrodepositable coating composition is “essentially free” of bismuth subnitrate if bismuth subnitrate is present, if at all, in trace or incidental amounts insufficient to affect any properties of the composition, such as, e.g., less than 0.001% by weight, based on the total resin solids weight of the composition. As used herein, an electrodepositable coating composition is “completely free” of bismuth subnitrate if bismuth subnitrate is not present in the composition, i.e., 0.000% by weight, based on the total resin solids weight of the composition.

The electrodepositable coating composition may be substantially free, essentially free, or completely free of bismuth oxide. As used herein, an electrodepositable coating composition is “substantially free” of bismuth oxide if bismuth oxide is present, if at all, in an amount less than 0.01% by weight, based on the total resin solids weight of the composition. As used herein, an electrodepositable coating composition is “essentially free” of bismuth oxide if bismuth oxide is present, if at all, in trace or incidental amounts insufficient to affect any properties of the composition, such as, e.g., less than 0.001% by weight, based on the total resin solids weight of the composition. As used herein, an electrodepositable coating composition is “completely free” of bismuth oxide if bismuth oxide is not present in the composition, i.e., 0.000% by weight, based on the total resin solids weight of the composition.

The electrodepositable coating composition may be substantially free, essentially free, or completely free of bismuth silicate. As used herein, an electrodepositable coating composition is “substantially free” of bismuth silicate if bismuth silicate is present, if at all, in an amount less than 0.01% by weight, based on the total resin solids weight of the composition. As used herein, an electrodepositable coating composition is “essentially free” of bismuth silicate if bismuth silicate is present, if at all, in trace or incidental amounts insufficient to affect any properties of the composition, such as, e.g., less than 0.001% by weight, based on the total resin solids weight of the composition. As used herein, an electrodepositable coating composition is “completely free” of bismuth silicate if bismuth silicate is not present in the composition, i.e., 0.000% by weight, based on the total resin solids weight of the composition.

The electrodepositable coating composition may be substantially free, essentially free, or completely free of bismuth titanate. As used herein, an electrodepositable coating composition is “substantially free” of bismuth titanate if bismuth titanate is present, if at all, in an amount less than 0.01% by weight, based on the total resin solids weight of the composition. As used herein, an electrodepositable coating composition is “essentially free” of bismuth titanate if bismuth titanate is present, if at all, in trace or incidental amounts insufficient to affect any properties of the composition, such as, e.g., less than 0.001% by weight, based on the total resin solids weight of the composition. As used herein, an electrodepositable coating composition is “completely free” of bismuth titanate if bismuth titanate is not present in the composition, i.e., 0.000% by weight, based on the total resin solids weight of the composition.

The electrodepositable coating composition may be substantially free, essentially free, or completely free of bismuth sulfamate. As used herein, an electrodepositable coating composition is “substantially free” of bismuth sulfamate if bismuth sulfamate is present, if at all, in an amount less than 0.01% by weight, based on the total resin solids weight of the composition. As used herein, an electrodepositable coating composition is “essentially free” of bismuth sulfamate if bismuth sulfamate is present, if at all, in trace or incidental amounts insufficient to affect any properties of the composition, such as, e.g., less than 0.001% by weight, based on the total resin solids weight of the composition. As used herein, an electrodepositable coating composition is “completely free” of bismuth sulfamate if bismuth sulfamate is not present in the composition, i.e., 0.000% by weight, based on the total resin solids weight of the composition.

The electrodepositable coating composition may be substantially free, essentially free, or completely free of bismuth lactate. As used herein, an electrodepositable coating composition is “substantially free” of bismuth lactate if bismuth lactate is present, if at all, in an amount less than 0.01% by weight, based on the total resin solids weight of the composition. As used herein, an electrodepositable coating composition is “essentially free” of bismuth lactate if bismuth lactate is present, if at all, in trace or incidental amounts insufficient to affect any properties of the composition, such as, e.g., less than 0.001% by weight, based on the total resin solids weight of the composition. As used herein, an electrodepositable coating composition is “completely free” of bismuth lactate if bismuth lactate is not present in the composition, i.e., 0.000% by weight, based on the total resin solids weight of the composition.

The electrodepositable coating composition may comprise a second addition polymer that is different from the hydroxyl-functional addition polymer.

The second addition polymer may comprise an acrylic polymer comprising a polymerization product of a polymeric dispersant and an aqueous dispersion of a second-stage ethylenically unsaturated monomer composition. As used herein, the term “acrylic polymer” refers to a polymerization product at least partially comprising the residue of (meth)acrylic monomers. The polymerization product may be formed by a two-stage polymerization process, wherein the polymeric dispersant is polymerized during the first stage and the second-stage ethylenically unsaturated monomer composition is added to an aqueous dispersion of the polymeric dispersant and polymerized in the presence of the polymeric dispersant that participates in the polymerization to form the acrylic polymer during the second stage. A non-limiting example of an acrylic polymer comprising a polymerization product of a polymeric dispersant and an aqueous dispersion of a second-stage ethylenically unsaturated monomer composition is described in Int'l Pub. No. WO 2018/160799 A1, at par. [0013] to [0055], the cited portion of which is incorporated herein by reference.

The second addition polymer may alternatively comprise a polymerization product of a polymeric dispersant and a second stage ethylenically unsaturated monomer composition comprising a second stage (meth)acrylamide monomer. A non-limiting example of a polymerization product of a polymeric dispersant and a second stage ethylenically unsaturated monomer composition comprising a second stage (meth)acrylamide monomer is described in PCT Pat. Appln. No. PCT/US2022/070969, at par. [0012] to [0066], the cited portion of which is incorporated herein by reference.

The second addition polymer described above may be present in the electrodepositable coating composition in an amount of at least 0.01% by weight, such as at least 0.1% by weight, such as at least 0.3% by weight, such as at least 0.5% by weight, such as at least 0.75% by weight, such as 1% by weight, based on the total weight of the resin solids of the electrodepositable coating composition. The second addition polymer described above may be present in the electrodepositable coating composition in an amount no more than 5% by weight, such as no more than 3% by weight, such as no more than 2% by weight, such as no more than 1.5% by weight, such as no more than 1% by weight, such as n no more than 0.75% by weight, based on the total weight of the resin solids of the electrodepositable coating composition. The second addition polymer may be present in the electrodepositable coating composition in an amount of 0.01% to 5% by weight, such as 0.01% to 3% by weight, such as 0.01% to 2% by weight, such as 0.01% to 1.5% by weight, such as 0.01% to 1% by weight, such as 0.01% to 0.75% by weight, such as 0.1% to 5% by weight, such as 0.1% to 3% by weight, such as 0.1% to 2% by weight, such as 0.1% to 1.5% by weight, such as 0.1% to 1% by weight, such as 0.1% to 0.75% by weight, such as 0.3% to 5% by weight, such as 0.3% to 3% by weight, such as 0.3% to 2% by weight, such as 0.3% to 1.5% by weight, such as 0.3% to 1% by weight, such as 0.3% to 0.75% by weight, such as 0.5% to 5% by weight, such as 0.5% to 3% by weight, such as 0.5% to 2% by weight, such as 0.5% to 1.5% by weight, such as 0.5% to 1% by weight, such as 0.5% to 0.75% by weight, such as 1% to 5% by weight, such as 1% to 3% by weight, such as 1% to 2% by weight, such as 1% to 1.5% by weight, based on the total weight of the resin solids of the electrodepositable coating composition.

The electrodepositable coating compositions of the present disclosure may optionally comprise crater control additives which may be incorporated into the coating composition, such as, for example, a polyalkylene oxide polymer which may comprise a copolymer of butylene oxide and propylene oxide. The molar ratio of butylene oxide to propylene oxide may be at least 1:1, such as at least 3:1, such as at least 5:1, and in some instances, may be no more than 50:1, such as no more than 30:1, such as no more than 20:1. The molar ratio of butylene oxide to propylene oxide may be 1:1 to 50:1, such as 3:1 to 30:1, such as 5:1 to 20:1.

The polyalkylene oxide polymer may comprise at least two hydroxyl functional groups, and may be monofunctional, difunctional, trifunctional, or tetrafunctional. As used herein, a “hydroxyl functional group” comprises an —OH group. For clarity, the polyalkylene oxide polymer may comprise additional functional groups in addition to the hydroxyl functional group(s). As used herein, “monofunctional,” when used with respect to the number of hydroxyl functional groups a particular monomer or polymer comprises, means a monomer or polymer comprising one (1) hydroxyl functional group per molecule. As used herein, “difunctional,” when used with respect to the number of hydroxyl functional groups a particular monomer or polymer comprises, means a monomer or polymer comprising two (2) hydroxyl functional groups per molecule. As used herein, “trifunctional,” when used with respect to the number of hydroxyl functional groups a particular monomer or polymer comprises, means a monomer or polymer comprising three (3) hydroxyl functional groups per molecule. As used herein, “tetrafunctional,” when used with respect to the number of hydroxyl functional groups a particular monomer or polymer comprises, means a monomer or polymer comprising four (4) hydroxyl functional groups per molecule.

The hydroxyl equivalent weight of the polyalkylene oxide polymer may be at least 100 g/mol, such as at least 200 g/mol, such as at least 400 g/mol, and may be no more than 2,000 g/mol, such as no more than 1,000 g/mol, such as no more than 800 g/mol. The hydroxyl equivalent weight of the polyalkylene oxide polymer may be 100 g/mol to 2,000 g/mol, such as 200 g/mol to 1,000 g/mol, such as 400 g/mol to 800 g/mol. As used herein, with respect to the polyalkylene oxide polymer, the “hydroxyl equivalent weight” is determined by dividing the molecular weight of the polyalkylene oxide polymer by the number of hydroxyl groups present in the polyalkylene oxide polymer.

The polyalkylene oxide polymer may have a z-average molecular weight (M_{z}) of at least 200 g/mol, such as at least 400 g/mol, such as at least 600 g/mol, and may be no more than 5,000 g/mol, such as no more than 3,000 g/mol, such as no more than 2,000 g/mol. The polyalkylene oxide polymer may have a z-average molecular weight of 200 g/mol to 5,000 g/mol, such as 400 g/mol to 3,000 g/mol, such as 600 g/mol to 2,000 g/mol. As used herein, with respect to polyalkylene oxide polymers having a z-average molecular weight (M_{z}) of less than 900,000, the term “z-average molecular weight (M_{z})” means the z-average molecular weight (M_{z}) as determined by Gel Permeation Chromatography using Waters 2695 separation module with a Waters 410 differential refractometer (RI detector), polystyrene standards having molecular weights of from approximately 500 g/mol to 900,000 g/mol, tetrahydrofuran (THF) with 0.05 M lithium bromide (LiBr) as the eluent at a flow rate of 0.5 m/min, and one Asahipak GF-510 HQ column for separation.

The polyalkylene oxide polymer may be present in the electrodepositable coating composition in an amount of at least 0.1% by weight based on the total weight of the resin blend solids, such as at least 0.5% by weight, such as at least 0.75% by weight, and in some instances, may be present in the electrodepositable coating composition in an amount of no more than 10% by weight based on the total weight of the resin blend solids, such as no more than 4% by weight, such as no more than 3% by weight. The polyalkylene oxide polymer may be present in the electrodepositable coating composition in an amount of at 0.1% by weight to 10% by weight based on the total weight of the resin blend solids, such as 0.5% by weight to 4% by weight, such as 0.75% by weight to 3% by weight.

The electrodepositable coating composition may optionally further comprise bis[2-(2-butoxyethoxy)ethoxy]methane. The bis[2-(2-butoxyethoxy)ethoxy]methane may be present in an amount of at least 0.1% by weight, such as at least 0.5% by weight, based on the resin solids weight. The bis[2-(2-butoxyethoxy)ethoxy]methane may be present in an amount of no more than 15% by weight, such as no more than 10% by weight, such as no more than 3% by weight, based on the resin solids weight. The bis[2-(2-butoxyethoxy)ethoxy]methane may be present in an amount of 0.1% to 15% by weight, such as 0.1% to 10% by weight, such as 0.1% to 3% by weight, such as 0.5% to 15% by weight, such as 0.5% to 10% by weight, such as 0.5% to 3% by weight, based on the resin solids weight.

The electrodepositable coating composition may comprise other optional ingredients, such as if desired, various additives such as fillers, plasticizers, anti-oxidants, biocides, UV light absorbers and stabilizers, hindered amine light stabilizers, defoamers, fungicides, dispersing aids, flow control agents, surfactants, wetting agents, or combinations thereof. Alternatively, the electrodepositable coating composition may be completely free of any of the optional ingredients, i.e., the optional ingredient is not present in the electrodepositable coating composition. The other additives mentioned above may be present in the electrodepositable coating composition in amounts of 0.01% to 3% by weight, based on total weight of the resin solids of the electrodepositable coating composition.

The electrodepositable coating composition may comprise water and/or one or more organic solvent(s). Water can for example be present in amounts of 40% to 90% by weight, such as 50% to 75% by weight, based on total weight of the electrodepositable coating composition. Examples of suitable organic solvents include oxygenated organic solvents, such as monoalkyl ethers of ethylene glycol, diethylene glycol, propylene glycol, and dipropylene glycol which contain from 1 to 10 carbon atoms in the alkyl group, such as the monoethyl and monobutyl ethers of these glycols. Examples of other at least partially water-miscible solvents include alcohols such as ethanol, isopropanol, butanol and diacetone alcohol. If used, the organic solvents may typically be present in an amount of less than 10% by weight, such as less than 5% by weight, based on total weight of the electrodepositable coating composition. The electrodepositable coating composition may in particular be provided in the form of a dispersion, such as an aqueous dispersion.

The total solids content of the electrodepositable coating composition may be at least 1% by weight, such as at least 5% by weight, and may be no more than 50% by weight, such as no more than 40% by weight, such as no more than 20% by weight, based on the total weight of the electrodepositable coating composition. The total solids content of the electrodepositable coating composition may be from 1% to 50% by weight, such as 5% to 40% by weight, such as 5% to 20% by weight, based on the total weight of the electrodepositable coating composition. As used herein, “total solids” refers to the non-volatile content of the electrodepositable coating composition, i.e., materials which will not volatilize when heated to 110° C. for 15 minutes.

### Substrates

The electrodepositable coating composition may be electrophoretically applied to a substrate. The cationic electrodepositable coating composition may be electrophoretically deposited upon any electrically conductive substrate. Suitable substrates include metal substrates, metal alloy substrates, and/or substrates that have been metallized, such as nickel-plated plastic. Additionally, substrates may comprise non-metal conductive materials including composite materials such as, for example, materials comprising carbon fibers or conductive carbon. The metal or metal alloy may comprise cold rolled steel, hot rolled steel, steel coated with zinc metal, zinc compounds, or zinc alloys, such as electrogalvanized steel, hot-dipped galvanized steel, galvannealed steel, and steel plated with zinc alloy. Aluminum alloys of the 2XXX, 5XXX, 6XXX, or 7XXX series as well as clad aluminum alloys and cast aluminum alloys of the A356 series also may be used as the substrate. Magnesium alloys of the AZ31B, AZ91C, AM60B, or EV31A series also may be used as the substrate. The substrate used in the present disclosure may also comprise titanium and/or titanium alloys. Other suitable non-ferrous metals include copper and magnesium, as well as alloys of these materials. Suitable metal substrates for use in the present disclosure include those that are often used in the assembly of vehicular bodies (e.g., without limitation, door, body panel, trunk deck lid, roof panel, hood, roof and/or stringers, rivets, landing gear components, and/or skins used on an aircraft), a vehicular frame, vehicular parts, motorcycles, wheels, industrial structures and components such as appliances, including washers, dryers, refrigerators, stoves, dishwashers, and the like, agricultural equipment, lawn and garden equipment, air conditioning units, heat pump units, lawn furniture, and other articles. As used herein, “vehicle” or variations thereof includes, but is not limited to, civilian, commercial and military aircraft, and/or land vehicles such as cars, motorcycles, and/or trucks. The metal substrate also may be in the form of, for example, a sheet of metal or a fabricated part. It will also be understood that the substrate may be pretreated with a pretreatment solution including a zinc phosphate pretreatment solution such as, for example, those described in U.S. Pat. Nos. 4,793,867 and 5,588,989, or a zirconium containing pretreatment solution such as, for example, those described in U.S. Pat. Nos. 7,749,368 and 8,673,091.

### Methods of Coating, Coatings and Coated Substrates

The present disclosure is also directed to methods for coating a substrate, such as any one of the electroconductive substrates mentioned above. According to the present disclosure such method may comprise electrophoretically applying an electrodepositable coating composition as described above to at least a portion of the substrate and curing the coating composition to form an at least partially cured coating on the substrate. According to the present disclosure, the method may comprise (a) electrophoretically depositing onto at least a portion of the substrate an electrodepositable coating composition of the present disclosure and (b) heating the coated substrate to a temperature and for a time sufficient to cure the electrodeposited coating on the substrate. According to the present disclosure, the method may optionally further comprise (c) applying directly to the at least partially cured electrodeposited coating one or more pigment-containing coating compositions and/or one or more pigment-free coating compositions to form a topcoat over at least a portion of the at least partially cured electrodeposited coating, and (d) heating the coated substrate of step (c) to a temperature and for a time sufficient to cure the topcoat.

The cationic electrodepositable coating composition of the present disclosure may be deposited upon an electrically conductive substrate by placing the composition in contact with an electrically conductive cathode and an electrically conductive anode, with the surface to be coated being the cathode. Following contact with the composition, an adherent film of the coating composition is deposited on the cathode when a sufficient voltage is impressed between the electrodes. The conditions under which the electrodeposition is carried out are, in general, similar to those used in electrodeposition of other types of coatings. The applied voltage may be varied and can be, for example, as low as one volt to as high as several thousand volts, such as between 50 and 500 volts. The current density may be between 0.5 ampere and 15 amperes per square foot and tends to decrease during electrodeposition indicating the formation of an insulating film.

Once the cationic electrodepositable coating composition is electrodeposited over at least a portion of the electroconductive substrate, the coated substrate is heated to a temperature and for a time sufficient to at least partially cure the electrodeposited coating on the substrate. As used herein, the term “at least partially cured” with respect to a coating refers to a coating formed by subjecting the coating composition to curing conditions such that a chemical reaction of at least a portion of the reactive groups of the components of the coating composition occurs to form a coating. The coated substrate may be heated to a temperature ranging from 250° F. to 450° F. (121.1° C. to 232.2° C.), such as from 275° F. to 400° F. (135° C. to 204.4° C.), such as from 300° F. to 360° F. (149° C. to 180° C.). The curing time may be dependent upon the curing temperature as well as other variables, for example, the film thickness of the electrodeposited coating, level and type of catalyst present in the composition and the like. For purposes of the present disclosure, all that is necessary is that the time be sufficient to effect cure of the coating on the substrate. For example, the curing time can range from 10 minutes to 60 minutes, such as 20 to 40 minutes. The thickness of the resultant cured electrodeposited coating may range from 15 to 50 microns.

The anionic electrodepositable coating composition of the present disclosure may be deposited upon an electrically conductive substrate by placing the composition in contact with an electrically conductive cathode and an electrically conductive anode, with the surface to be coated being the anode. Following contact with the composition, an adherent film of the coating composition is deposited on the anode when a sufficient voltage is impressed between the electrodes. The conditions under which the electrodeposition is carried out are, in general, similar to those used in electrodeposition of other types of coatings. The applied voltage may be varied and can be, for example, as low as one volt to as high as several thousand volts, such as between 50 and 500 volts. The current density may be between 0.5 ampere and 15 amperes per square foot and tends to decrease during electrodeposition indicating the formation of an insulating film.

Once the anionic electrodepositable coating composition is electrodeposited over at least a portion of the electroconductive substrate, the coated substrate may be heated to a temperature and for a time sufficient to at least partially cure the electrodeposited coating on the substrate. As used herein, the term “at least partially cured” with respect to a coating refers to a coating formed by subjecting the coating composition to curing conditions such that a chemical reaction of at least a portion of the reactive groups of the components of the coating composition occurs to form a coating. The coated substrate may be heated to a temperature ranging from 200° F. to 450° F. (93° C. to 232.2° C.), such as from 275° F. to 400° F. (135° C. to 204.4° C.), such as from 300° F. to 360° F. (149° C. to 180° C.). The curing time may be dependent upon the curing temperature as well as other variables, for example, film thickness of the electrodeposited coating, level and type of catalyst present in the composition and the like. For purposes of the present disclosure, all that is necessary is that the time be sufficient to effect cure of the coating on the substrate. For example, the curing time may range from 10 to 60 minutes, such as 20 to 40 minutes. The thickness of the resultant cured electrodeposited coating may range from 15 to 50 microns.

The electrodepositable coating compositions of the present disclosure may also, if desired, be applied to a substrate using non-electrophoretic coating application techniques, such as flow, dip, spray and roll coating applications. For non-electrophoretic coating applications, the coating compositions may be applied to conductive substrates as well as non-conductive substrates such as glass, wood and plastic.

The present disclosure is further directed to a coating formed by at least partially curing the electrodepositable coating composition described herein.

The present disclosure is further directed to a substrate that is coated, at least in part, with the electrodepositable coating composition described herein in an at least partially cured state. The coated substrate may comprise a coating comprising a hydroxyl functional addition polymer comprising constitutional units, at least 70% of which comprise formula I:

—[—C(R¹)₂—C(R¹)(OH)—]— (I),

wherein each R¹ is independently one of hydrogen, an alkyl group, a substituted alkyl group, a cycloalkyl group, a substituted cycloalkyl group, an alkylcycloalkyl group, a substituted alkylcycloalkyl group, a cycloalkylalkyl group, a substituted cycloalkylalkyl group, an aryl group, a substituted aryl group, an alkylaryl group, a substituted alkylaryl group, a cycloalkylaryl group, a substituted cycloalkylaryl group, an arylalkyl group, a substituted arylalkyl group, an arylcycloalkyl group, or a substituted arylcycloalkyl group; an active hydrogen-containing, ionic salt group-containing film-forming polymer different from the addition polymer; a curing agent; and an amine-containing curing catalyst and/or a zinc-containing curing catalyst.

The electrodepositable coating compositions of the present disclosure may be utilized in an electrocoating layer that is part of a multi-layer coating composite comprising a substrate with various coating layers. The coating layers may include a pretreatment layer, such as a phosphate layer (e.g., zinc phosphate layer), an electrocoating layer which results from the aqueous resinous dispersion of the present disclosure, and suitable topcoat layers (e.g., base coat, clear coat layer, pigmented monocoat, and color-plus-clear composite compositions). It is understood that suitable topcoat layers include any of those known in the art, and each independently may be waterborne, solventborne, in solid particulate form (i.e., a powder coating composition), or in the form of a powder slurry. The topcoat typically includes a film-forming polymer, crosslinking material and, if a colored base coat or monocoat, one or more pigments. According to the present disclosure, the primer layer may be disposed between the electrocoating layer and the base coat layer. According to the present disclosure, one or more of the topcoat layers are applied onto a substantially uncured underlying layer. For example, a clear coat layer may be applied onto at least a portion of a substantially uncured basecoat layer (wet-on-wet), and both layers may be simultaneously cured in a downstream process.

Moreover, the topcoat layers may be applied directly onto the electrodepositable coating layer. In other words, the substrate lacks a primer layer. For example, a basecoat layer may be applied directly onto at least a portion of the electrodepositable coating layer.

It will also be understood that the topcoat layers may be applied onto an underlying layer despite the fact that the underlying layer has not been fully cured. For example, a clearcoat layer may be applied onto a basecoat layer even though the basecoat layer has not been subjected to a curing step. Both layers may then be cured during a subsequent curing step thereby eliminating the need to cure the basecoat layer and the clearcoat layer separately.

According to the present disclosure, additional ingredients such as colorants and fillers may be present in the various coating compositions from which the topcoat layers result. Any suitable colorants and fillers may be used. For example, the colorant may be added to the coating in any suitable form, such as discrete particles, dispersions, solutions and/or flakes. A single colorant or a mixture of two or more colorants can be used in the coatings of the present disclosure. It should be noted that, in general, the colorant can be present in a layer of the multi-layer composite in any amount sufficient to impart the desired property, visual and/or color effect.

Example colorants include pigments, dyes and tints, such as those used in the paint industry and/or listed in the Dry Color Manufacturers Association (DCMA), as well as special effect compositions. A colorant may include, for example, a finely divided solid powder that is insoluble but wettable under the conditions of use. A colorant may be organic or inorganic and may be agglomerated or non-agglomerated. Colorants may be incorporated into the coatings by grinding or simple mixing. Colorants may be incorporated by grinding into the coating by use of a grind vehicle, such as an acrylic grind vehicle, the use of which will be familiar to one skilled in the art.

Example pigments and/or pigment compositions include, but are not limited to, carbazole dioxazine crude pigment, azo, monoazo, disazo, naphthol AS, salt type (lakes), benzimidazolone, condensation, metal complex, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPP red BO”), titanium dioxide, carbon black, zinc oxide, antimony oxide, etc. and organic or inorganic UV opacifying pigments such as iron oxide, transparent red or yellow iron oxide, phthalocyanine blue and mixtures thereof. The terms “pigment” and “colored filler” can be used interchangeably.

Example dyes include, but are not limited to, those that are solvent and/or aqueous based such as acid dyes, azoic dyes, basic dyes, direct dyes, disperse dyes, reactive dyes, solvent dyes, sulfur dyes, mordant dyes, for example, bismuth vanadate, anthraquinone, perylene, aluminum, quinacridone, thiazole, thiazine, azo, indigoid, nitro, nitroso, oxazine, phthalocyanine, quinoline, stilbene, and triphenyl methane.

Example tints include, but are not limited to, pigments dispersed in water-based or water miscible carriers such as AQUA-CHEM 896 commercially available from Degussa, Inc., CHARISMA COLORANTS and MAXITONER INDUSTRIAL COLORANTS commercially available from Accurate Dispersions division of Eastman Chemical, Inc.

The colorant may be in the form of a dispersion including, but not limited to, a nanoparticle dispersion. Nanoparticle dispersions can include one or more highly dispersed nanoparticle colorants and/or colorant particles that produce a desired visible color and/or opacity and/or visual effect. Nanoparticle dispersions may include colorants such as pigments or dyes having a particle size of less than 150 nm, such as less than 70 nm, or less than 30 nm. Nanoparticles may be produced by milling stock organic or inorganic pigments with grinding media having a particle size of less than 0.5 mm. Example nanoparticle dispersions and methods for making them are identified in U.S. Pat. No. 6,875,800 B2, which is incorporated herein by reference. Nanoparticle dispersions may also be produced by crystallization, precipitation, gas phase condensation, and chemical attrition (i.e., partial dissolution). In order to minimize re-agglomeration of nanoparticles within the coating, a dispersion of resin-coated nanoparticles may be used. As used herein, a “dispersion of resin-coated nanoparticles” refers to a continuous phase in which is dispersed discreet “composite microparticles” that comprise a nanoparticle and a resin coating on the nanoparticle. Example dispersions of resin-coated nanoparticles and methods for making them are identified in U.S. patent application Ser. No. 10/876,031 filed Jun. 24, 2004, which is incorporated herein by reference, and U.S. Provisional Pat. Application No. 60/482,167 filed Jun. 24, 2003, which is also incorporated herein by reference.

According to the present disclosure, special effect compositions that may be used in one or more layers of the multi-layer coating composite include pigments and/or compositions that produce one or more appearance effects such as reflectance, pearlescence, metallic sheen, phosphorescence, fluorescence, photochromism, photosensitivity, thermochromism, goniochromism and/or color-change. Additional special effect compositions may provide other perceptible properties, such as reflectivity, opacity or texture. For example, special effect compositions may produce a color shift, such that the color of the coating changes when the coating is viewed at different angles. Example color effect compositions are identified in U.S. Pat. No. 6,894,086, incorporated herein by reference. Additional color effect compositions may include transparent coated mica and/or synthetic mica, coated silica, coated alumina, a transparent liquid crystal pigment, a liquid crystal coating, and/or any composition wherein interference results from a refractive index differential within the material and not because of the refractive index differential between the surface of the material and the air.

According to the present disclosure, a photosensitive composition and/or photochromic composition, which reversibly alters its color when exposed to one or more light sources, can be used in a number of layers in the multi-layer composite. Photochromic and/or photosensitive compositions can be activated by exposure to radiation of a specified wavelength. When the composition becomes excited, the molecular structure is changed and the altered structure exhibits a new color that is different from the original color of the composition. When the exposure to radiation is removed, the photochromic and/or photosensitive composition can return to a state of rest, in which the original color of the composition returns. For example, the photochromic and/or photosensitive composition may be colorless in a non-excited state and exhibit a color in an excited state. Full color-change may appear within milliseconds to several minutes, such as from 20 seconds to 60 seconds. Example photochromic and/or photosensitive compositions include photochromic dyes.

According to the present disclosure, the photosensitive composition and/or photochromic composition may be associated with and/or at least partially bound to, such as by covalent bonding, a polymer and/or polymeric materials of a polymerizable component. In contrast to some coatings in which the photosensitive composition may migrate out of the coating and crystallize into the substrate, the photosensitive composition and/or photochromic composition associated with and/or at least partially bound to a polymer and/or polymerizable component in accordance with the present disclosure, have minimal migration out of the coating. Example photosensitive compositions and/or photochromic compositions and methods for making them are identified in U.S. patent application Ser. No. 10/892,919 filed Jul. 16, 2004 and incorporated herein by reference.

For purposes of this detailed description, it is to be understood that the disclosure may assume alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

As used herein, “including,” “containing” and like terms are understood in the context of this application to be synonymous with “comprising” and are therefore open-ended and do not exclude the presence of additional undescribed or unrecited elements, materials, ingredients or method steps. As used herein, “consisting of” is understood in the context of this application to exclude the presence of any unspecified element, ingredient or method step. As used herein, “consisting essentially of” is understood in the context of this application to include the specified elements, materials, ingredients or method steps “and those that do not materially affect the basic and novel characteristic(s)” of what is being described.

In this application, the use of the singular includes the plural and plural encompasses singular, unless specifically stated otherwise. For example, although reference is made herein to “an” ionic salt group-containing film-forming polymer, “a” hydroxyl functional addition polymer, “a” monomer, “an” ionic salt group-containing film-forming polymer, “a” blocked polyisocyanate curing agent, a combination (i.e., a plurality) of these components may be used. In addition, in this application, the use of “or” means “and/or” unless specifically stated otherwise, even though “and/or” may be explicitly used in certain instances.

Whereas specific aspects of the disclosure have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosure which is to be given the full breadth of the claims appended and any and all equivalents thereof.

Illustrating the disclosure are the following examples, which, however, are not to be considered as limiting the disclosure to their details. Unless otherwise indicated, all parts and percentages in the following examples, as well as throughout the specification, are by weight.

### EXAMPLES

### Example 1: Prep. Of a Comparative Blocked Polyisocyanate Curing Agent (Crosslinker I)

A blocked polyisocyanate curing agent was prepared in the following manner: Components 2-7 listed in Table 1, below, were mixed in a flask set up for total reflux with stirring under nitrogen. The mixture was heated to a temperature of 30° C., and Component 1 was added dropwise so that the temperature increased due to the reaction exotherm and was maintained under 100° C. After the addition of Component 1 was complete, a temperature of 100° C. was established in the reaction mixture and the reaction mixture held at temperature until no residual isocyanate was detected by IR spectroscopy. Component 8 was then added, and the reaction mixture was allowed to stir for 30 minutes before cooling to ambient temperature.

TABLE 1

| No. | Component | Parts by Weight |
|---|---|---|
| 1 | Polymeric methylene diphenyl | 1675.50 |
| | diisocyanate¹ | |
| 2 | Dibutyltin dilaurate | 1.46 |
| 3 | Methyl isobutyl ketone | 235.52 |
| 4 | 2-Butoxyethanol | 663.75 |
| 5 | Dipropylene glycol monomethyl ether | 462.50 |
| 6 | Methanol | 120.00 |
| 7 | (2-(2-Butoxyethoxy)ethanol) | 0.134 |
| 8 | Methyl isobutyl ketone | 180.34 |

¹Rubinate M, available from Huntsman Corporation.

### Example 2: Preparation of a Cationic, Amine-Functionalized, Polyepoxide-Based Resin

A cationic, amine-functionalized, polyepoxide-based polymeric resin was prepared in the following manner. Components 1-7 listed in Table 2, below, were mixed in a flask set up for total reflux with stirring under nitrogen. The mixture was heated to a temperature of 130° C. and allowed to exotherm (175° C. maximum). A temperature of 145° C. was established in the reaction mixture and the reaction mixture was then held for 2 hours. Component 8 was introduced slowly while allowing the mixture to cool to 125° C. followed by the addition of Component 9. A temperature of 105° C. was established, and Components 10 and 11 were then added to the reaction mixture quickly (sequential addition) and the reaction mixture was allowed to exotherm. A temperature of 120° C. was established and the reaction mixture held for 1 hour, resulting in Resin Synthesis Products A-B. For product C, when the temperature reached 120° C., component 12 was added and stirred for 15 minutes.

A portion of the Resin Synthesis Product A-C(Component 13) was then poured into a pre-mixed solution of Components 14 and 15 to form a resin dispersion, and the resin dispersion was stirred for 1 hour. Component 16 was then introduced over 30 minutes to further dilute the resin dispersion, followed by the addition of Component 17. The free MIBK in the resin dispersion was removed from the dispersion under vacuum at a temperature of 60-70° C.

The solids content of the resulting cationic, amine-functionalized, polyepoxide-based polymeric resin dispersion was determined by adding a quantity of the resin dispersion to a tared aluminum dish, recording the initial weight of the resin dispersion, heating the resin dispersion in the dish for 60 minutes at 110° C. in an oven, allowing the dish to cool to ambient temperature, reweighing the dish to determine the amount of non-volatile content remaining, and calculating the solids content by dividing the weight of the remaining non-volatile content by the initial resin dispersion weight and multiplying by 100. (Note, this procedure was used to determine the solids content in each of resin dispersion examples described below). The solids contents of Resin Dispersions A-C are reported in Table 2.

TABLE 2

| | | Resin Example: | | |
|---|---|---|---|---|
| | | A | B | C |
| No. | Material | Resin Synthesis Stage - Parts by Weight | | |
| 1 | EPON 828¹ | 614.7 | 614.7 | 614.7 |
| 2 | Bisphenol A | 217.7 | 154.8 | 217.7 |
| 3 | 4-Dodecylphenol | — | 237.5 | — |
| 4 | Bisphenol A - ethylene | 136.0 | 155.5 | 140.0 |
| | oxide adduct (1/6 molar | | | |
| | ratio BPA/EO) | | | |
| 5 | Polypropylene Glycol | 45.3 | 51.8 | 46.7 |
| | 725 | | | |
| 6 | Methyl isobutyl ketone | 33.0 | 37.6 | 33.2 |
| | (MIBK) | | | |
| 7 | Ethyl triphenyl | 80.2 | 0.3 | 0.3 |
| | phosphonium bromide | | | |
| 8 | Methyl isobutyl ketone | 102.1 | 91.0 | 81.34 |
| 9 | Example 1 | 653.7 | 743.4 | 670.9 |
| 10 | Diethylene triamine - | 51.5 | 58.5 | 51.5 |
| | MIBK diketimine ² | | | |
| 11 | Methyl Ethanol Amine | 46.9 | 53.3 | 46.9 |
| 12 | K-KAT XK-620³ | — | — | 29.6 |
| 13 | Resin synthesis stage | 1788.1 | 1890.5 | 1708.28 |
| | product | | | |
| 14 | Formic Acid (90% | 25.3 | 26.7 | 24.17 |
| | in water) | | | |
| 15 | DI Water | 1088.9 | 1151.3 | 1040.35 |
| 16 | DI Water | 1190.7 | 1258.9 | 1137.6 |
| 17 | DI Water | 1000.0 | 1000.0 | 1000.0 |
| | Dispersion Solids (wt %) | 39.8 | 38.61 | 39.26 |

¹Diglycidyl ether of Bisphenol A with an epoxy equivalent weight of 186-190.
² 72.7% by weight (in MIBK) of the diketimine reaction product of 1 equivalent of diethylene triamine and 2 equivalents of MIBK.
³Supplied by King Industries

### Example 3: Preparation of Polyvinyl Alcohol Solution

Component 1 was added to a 1 L glass jar. The liquid was agitated while component 2 was added over 30 minutes with one quarter of the material added every 5-minutes. After stirring for 1-3 hours, mixing was stopped, and the solution was headed to 71° C. for 16 hours. The solution was then cooled to room temperature.

TABLE 3

| | Material | Solution 1 | Solution 2 |
|---|---|---|---|
| 1 | DI Water | 500 | 500 |
| 2 | Hydroxyl-functional addition polymer¹ | 50 | — |
| | Hydroxyl-functional addition polymer² | — | 50 |

¹Polyvinyl alcohol polymer having a reported weight average molecular weight of 214,500 g/mol, a reported hydrolysis amount of 88%, and a reported viscosity of 20.5 to 24.5 cP for a 4% by weight aqueous solution at 20° C. measured using a Brookfield synchronized-motor rotary type viscometer, commercially available as Kuraray POVAL ™ 22-88 from Kuraray.
²Polyvinyl alcohol polymer having a reported weight average molecular weight of 310,800 g/mol, a reported hydrolysis amount of 88%, and a reported viscosity of 90.0 to 110.0 cP for a 4% by weight aqueous solution at 20° C. measured using a Brookfield synchronized-motor rotary type viscometer, commercially available as Kuraray POVAL ™ 100-88 from Kuraray.

### Example 4: Synthesis of a Cationic Salt Group-Containing Polymeric Dispersant

TABLE 4

| Charge # | Material | Parts |
|---|---|---|
| 1 | Dowanol ™ PnB | 65.0 |
| | Dowanol ™ PM | 83.5 |
| | Butyl Cellosolve | 198.5 |
| | Deionized Water | 13.9 |
| 2 | Ethyl Acrylate | 353.4 |
| | Styrene | 62.1 |
| | 2-Hydroxypropyl Methacrylate | 93.0 |
| | Methyl Methacrylate | 260.4 |
| | Glycidyl Methacrylate | 139.5 |
| | Allyl Methacrylate | 11.5 |
| | t-Dodecyl Mercaptan | 9.3 |
| 3 | Vazo ™ 67¹ | 18.5 |
| | Dowanol ™ PnB | 29.5 |
| | Dowanol ™ PM | 14.8 |
| | Methyl Isobutyl Ketone | 11.8 |
| 4 | Lupersol 7M50 | 18.6 |
| | Dowanol ™ PnB | 14.8 |
| | Dowanol ™ PM | 7.4 |
| 5 | Butyl Cellosolve | 80.3 |
| 6 | Diethanol amine | 99.6 |
| 7 | Deionized Water | 3334.0 |
| | Formic Acid (90% in water) | 34.2 |
| 8 | Deionized water | 1151.5 |

¹2,2′-azobis(2-methylbutyronitrile) free radical initiator available from The Chemours Company.

A cationic salt group-containing polymeric dispersant was prepared from the components listed in Table 4 according to the following procedure: Charge 1 was added to a 4-necked flask fitted with a thermocouple, nitrogen sparge, and a mechanical stirrer. Under a nitrogen blanket and agitation, the flask was heated to reflux with a temperature set point of 100° C. Charges 2 and 3 were added dropwise from an addition funnel over 150 minutes followed by a 30-minute hold. After increasing the temperature to 120° C., charge 4 was subsequently added over 15 minutes followed by a 10-minute hold. The temperature was decreased to 110° C. while adding charge 5 to help cool the reaction. Charge 6 was added and the temperature was held at 115° C. for 3 hours. During the hold, charge 7 was heated to approximately 35-40° C. in a separate container outfitted with a mechanical stirrer. After the hold, the contents from the reactor were poured into the container that includes charge 7 under rapid agitation and then held for 60 minutes. Charge 8 was added under agitation as the dispersion continued to cool to ambient temperature (about 25° C.). The resulting aqueous dispersion of the cationic polymeric dispersant had a solids content of 16.70%.

The weight average molecular weight (Mw) and z-average molecular weight (Mz) were determined by Gel Permeation Chromatography (GPC). For polymers having a z-average molecular weight of less than 900,000, GPC was performed using a Waters 2695 separation module with a Waters 410 differential refractometer (RI detector), polystyrene standards having molecular weights of from approximately 500 g/mol to 900,000 g/mol, dimethylformamide (DMF) with 0.05 M lithium bromide (LiBr) as the eluent at a flow rate of 0.5 mL/min, and one Asahipak GF-510 HQ column for separation. With respect to polymers having a z-average molecular weight (Mz) of greater than 900,000 g/mol, GPC was performed using a Waters 2695 separation module with a Waters 410 differential refractometer (RI detector), polystyrene standards having molecular weights of from approximately 500 g/mol to 3,000,000 g/mol, dimethylformamide (DMF) with 0.05 M lithium bromide (LiBr) as the eluent at a flow rate of 0.5 m/min, and one Asahipak GF-7M HQ column for separation. This procedure was followed for all of the molecular weights measurements included in the Examples. It was determined that the cationic polymeric dispersant had a weight average molecular weight of 207,774 g/mol, and a z-average molecular weight of 1,079,872 g/mol.

### Example 5: Synthesis of an Acrylic Microgel

TABLE 5

| Charge # | Material | Parts |
|---|---|---|
| 1 | Product of Example 4 (cationic salt | 726.1 |
| | group-containing polymeric dispersant) | |
| | Deionized Water | 680.1 |
| 2 | Ethyl Acrylate | 87.6 |
| | Styrene | 93.8 |
| | 2-Hydroxypropyl Methacrylate | 20.9 |
| | Trimethylolpropane triacrylate | 6.2 |
| 3 | Deionized Water | 26.7 |
| | Hydrogen Peroxide (35% in Deionized | 3.2 |
| | Water) | |
| 4 | Iso-Ascorbic Acid | 0.6 |
| | Ferrous Ammonium Sulfate | 0.006 |
| | Deionized Water | 43.6 |
| 5 | Deionized Water | 5.0 |
| | Hydrogen Peroxide (35% in Deionized | 0.09 |
| | Water) | |
| 6 | Iso-Ascorbic Acid | 0.09 |
| | Deionized Water | 5.0 |

An aqueous dispersion of Comparative Addition Polymer D was formed from the ingredients included in Table 5. Comparative Addition Polymer D includes the cationic polymeric dispersant and an ethylenically unsaturated monomer composition having 10% by weight of a hydroxyl-functional (meth)acrylate (2-hydroxypropyl methacrylate), based on the weight of the ethylenically unsaturated monomer composition. The Comparative Addition Polymer D was prepared as follows: Charge 1 was added to a 4-necked flask fitted with a thermocouple, nitrogen sparge, and a mechanical stirrer. Under a nitrogen blanket and rigorous stirring, the flask was heated to 25° C. At 25° C., the solution was sparged under nitrogen for an additional 30 minutes. Charge 2 was then added to the reaction vessel over 10 minutes. Charge 3 was then added to the reaction vessel over 2-3 minutes. The components of charge 4 were mixed together and added to the reactor through an addition funnel over 30 minutes. The reaction was allowed to exotherm during the addition of charge 4. After the addition was complete, the reactor was heated to 50° C. and held at that temperature for 30 minutes. Charges 5 and 6 were added dropwise and held for 30 minutes at 50° C. The reactor was then cooled to ambient temperature.

The solids content of the resulting aqueous dispersion of Comparative Addition Polymer D was determined using the method described in Example 2. The measured solids content was 19.23%. The weight average molecular weight of Comparative Addition Polymer D was 655,838 g/mol and the z-average molecular weight of Comparative Addition Polymer D was 1,395,842 g/mol, as measured according to the method described in Example 4.

### Example 6: Preparation of a Bismuth Catalyst Solution

An aqueous bismuth methane sulfonate catalyst solution was prepared using the ingredients from Table 13 in the following manner: Component 1 was added to an Erlenmeyer flask with stirring, followed by the sequential introduction of Components 2 and 3. The content of the flask was stirred for 3 hours at room temperature, and the resulting catalyst solution was then filtered through a Buchner funnel to remove any undissolved residue.

TABLE 6

| # | Material | Parts |
|---|---|---|
| 1 | Deionized water | 3645.05 |
| 2 | Methanesulfonic acid¹ | 220.07 |
| 3 | Bismuth(III) oxide² | 172.16 |

¹70% solution in deionized water.
²5N Plus Frit grade.

TABLE 7
Example 7: Preparation of Grind Vehicle 1

| # | Material | Parts |
|---|---|---|
| 1 | EPON 828¹ | 533.2 |
| 2 | Nonyl phenol | 19.1 |
| 3 | Bisphenol A | 198.3 |
| 4 | Ethyltriphenyl phosphonium iodide | 0.7 |
| 5 | Butoxy propanol | 99.3 |
| | Subtotal | 850.6 |
| 6 | Butoxy propanol | 93.9 |
| 7 | Methoxy propanol | 50.3 |
| | Subtotal | 994.8 |
| 8 | Thiodiethanol | 121.3 |
| 9 | Butoxy propanol | 6.9 |
| 10 | Deionized water | 32.1 |
| 11 | Dimethylol propionic acid | 133.1 |
| | Subtotal | 1288.2 |
| 12 | Deionized water | 1100 |
| 13 | Deionized water | 790 |

¹Diglycidyl ether of Bisphenol A with an epoxy equivalent weight of 186-190.

Grind Vehicle 1 was prepared with the materials listed in Table 7 according to the following procedure: Materials 1 through 5 were charged to a suitably equipped flask and heat to 125° C. The mixture was allowed to exotherm to 175° C. and then held at 160-165° C. for 1 hr. After the 1-hour hold, Materials 6-7 were added. The mixture was then cooled to 80° C. and Materials 8-11 were added. The mixture was held at 78° C. until the measured acid value was less than 2, as measured using a Metrohm 799 MPT Titrino automatic titrator utilizing a 0.1 M potassium hydroxide solution in methanol. Then 1288.2 g of the resin was poured into 1100 g of deionized water (Material 12) with stirring. The mixture was mixed for 30 minutes before material 13 was added and mixed well.

### Example 8: Preparation of Grind Vehicle 2

This example describes the preparation of a quaternary ammonium salt containing pigment-grinding resin, Grind Vehicle 2. Grind Vehicle 2-1 describes the preparation of an amine-acid salt quaternizing agent and Grind Vehicle 2-2 describes the preparation of an epoxy group-containing polymer that is subsequently quaternized with the amine-acid salt of Grind Vehicle 2-1 to form Grind Vehicle 2.

Grind Vehicle 2-1: The amine-acid salt quaternizing agent was prepared using the materials listed in the table below according to the following procedure:

TABLE 8-1

| # | Material | Parts |
|---|---|---|
| 1 | Dimethyl ethanolamine | 445.0 |
| 2 | PAPI 290¹ | 661.1 |
| 3 | Bis[2-(2-butoxyethoxy)ethoxy]methane² | 22.1 |
| 4 | 88% lactic acid aqueous | 511.4 |
| 5 | Deionized water | 1026.4 |

¹Polymeric diisocyanate commercially available from Dow Chemical Co.
²Available as Mazon 1651 from BASF Corporation.

To a suitably equipped, four-neck flask, Component 1 was charged. Component 2 was then added over a 1.5 hr period, keeping the reaction temperature ≤100° C., followed by addition of Component 3. The resulting mixture was mixed at 90-95° C. until reaction of the isocyanate was complete, as determined by infrared spectroscopy, ˜1 hr. Components 4 and 5 were pre-mixed and added over 1 hr. A temperature of 85° C. was then established, and the mixture was held at this temperature for 3 hr to yield the amine-acid salt quaternizing agent.

Grind Vehicle 2-2: The quaternary ammonium salt group-containing polymer was prepared using the materials listed in the table below according to the following procedure:

TABLE 8-2

| # | Material | Parts |
|---|---|---|
| 1 | EPON 828¹ | 568.2 |
| 2 | Bisphenol A | 241.9 |
| 3 | Bisphenol A - ethylene oxide adduct (1/6 | 90.0 |
| | molar ratio BPA/EO) | |
| 4 | Bis[2-(2-butoxyethoxy)ethoxy]methane ² | 9.9 |
| 5 | Ethyltriphenylphosphonium iodide | 0.5 |
| 6 | Bis[2-(2-butoxyethoxy)ethoxy]methane ² | 142.9 |
| 7 | Bisphenol A diglycidyl ether¹ | 10.5 |
| 8 | Bis[2-(2-butoxyethoxy)ethoxy]methane ² | 9.0 |
| 9 | Amine-acid quaternizing agent from Grind | 314.9 |
| | Vehicle 2-1 above | |
| 10 | Deionized water | 1731.9 |

¹Diglycidyl ether of Bisphenol A with an epoxy equivalent weight of 186-190.
² Available as Mazon 1651 from BASF Corporation.

Components 1-5 were charged to a four-neck flask equipped with stirrer and reflux condenser. The reaction mixture was heated to about 140° C., then allowed to exotherm to about 180° C. A temperature of 160° C. was subsequently established, and the mixture was held at that temperature for 1 hr to achieve an epoxy equivalent weight of 900-1100 g/equiv. Component 6 was charged, and a temperature of 120° C. was established. Components 7-8 were then added, and the mixture was held at 120° C. for 1 hr. The temperature was subsequently lowered to 90° C. Components 9-10 were pre-mixed and then added over 1.5 hr. The reaction temperature was held at about 80° C. for approximately 6 hours until the acid number of the reaction product fell below 1.0, as measured using a Metrohm 799 MPT Titrino automatic titrator utilizing a 0.1 M potassium hydroxide solution in methanol.

### Example 9: Preparation of the Pigment Paste

Preparation of Pigment Paste 1: A pigment dispersion was prepared by sequentially adding the ingredients in the table below under higher shear agitation. When the ingredients were thoroughly blended, the pigment dispersion was transferred to a vertical sand mill and ground to a Hegman value of >7.5 as measured using a Hegman gauge.

TABLE 9A

| # | Material | Parts |
|---|---|---|
| 1 | Grind Vehicle 1 | 734.02 |
| 2 | n-butoxypropanol | 28.23 |
| 3 | Silica Pigment¹ | 96.95 |
| 4 | DI Water | 57.57 |

¹Gasil IJ35 supplied by INEOS.

Preparation of catalyst-free pigment paste: The catalyst free pigment dispersion was prepared by sequentially adding ingredients 1-7 listed below under high shear agitation. When the ingredients were thoroughly blended, the pigment dispersion was transferred to a vertical sand mill and ground to a Hegman value of >7.5. Charge 8 was then mixed into the paste with a Cowles blade for 1 hour. The resulting paste is referred to as the Pigment Paste of Example 9 herein.

TABLE 9B

| # | Material | Parts |
|---|---|---|
| 1 | Grind Vehicle 1 | 1928.77 |
| 2 | Grind Vehicle 2 | 1411.99 |
| 3 | N-butoxypropanol | 115.99 |
| 4 | Printex 200¹ | 93.00 |
| 5 | ASP 200² | 115.41 |
| 6 | Titanium Dioxide³ | 3256.59 |
| 7 | Deionized water | 70.98 |
| 8 | Pigment Paste 1 from Table 9A | 3339.60 |

¹Carbon Black pigment suppled from Orion Engineered Carbon
²Kaolin Clay available from BASF corporation
³Pigment grade from The Chemours Company

### Example 10: Preparation of Electrodepositable Coating Compositions A-L

For each paint composition, Charges 1-6 from the tables below were added sequentially into a plastic container at room temperature under agitation with 10 minutes of stirring after each addition. The mixture was stirred for at least 30 minutes at room temperature. Charge 7 was then added, and the paint was allowed to stir until uniform, a minimum of 30 minutes. Charge 8 was added, and the paint was allowed to stir for a minimum of 30 minutes until uniform. The resulting cationic electrodepositable paint compositions had a solids contend of 25%, determined as by described previously, and a pigment to binder ratio of 0.15/1.0 by weight.

After 20% ultrafiltration (and reconstitution with deionized water), coated panels were prepared from a bath containing the cationic electrodepositable coating composition

TABLE 10

| Charge | Material | A | B | C | D |
|---|---|---|---|---|---|
| 1 | Resin A | 1123.3 | 883.55 | 114.71 | 879.96 |
| | Resin B | — | — | — | — |
| | Resin C | — | — | — | — |
| 2 | Bis[2-(2- | 32.62 | 26.61 | 32.62 | 26.61 |
| | butoxyethoxy)ethoxy] | | | | |
| | methane¹ | | | | |
| 3 | Solution 1 of Ex. 3 | — | 19.01 | 34.21 | 57.52 |
| | Solution 2 of Ex. 3 | — | — | — | — |
| 4 | Example 5 | — | — | — | — |
| 5 | Example 6 | — | — | — | — |
| 6 | DI Water | 134.79 | 126.85 | 109.17 | 105.5 |
| 7 | E6478² | 276.5 | 230.5 | 276.5 | 230.5 |
| | Pig. Paste of Ex. 9 | — | — | — | — |
| 8 | Water | 856.2 | 713.5 | 956.2 | 713.5 |

¹Available as Mazon 1651 from BASF Corporation.
²Pigment paste E6478 available from PPG Industries consisting of 52% solids at a P:B of 1.22. Contains 0.324% by weight of the guanidine catalyst described in U.S. Pat. No. 7,842,762, the % by weight based on total weight of the pigment paste.

TABLE 11

| Charge | Material | E | F | G | H |
|---|---|---|---|---|---|
| 1 | Resin A | 1121.01 | 1117.57 | 1076.78 | 1108.98 |
| 2 | Bis[2-(2- | 32.62 | 32.92 | 32.52 | 32.22 |
| | butoxyethoxy)ethoxy] | | | | |
| | methane¹ | | | | |
| 3 | Solution 2 of Ex. 3 | 9.12 | 22.81 | 34.84 | 57.02 |
| 4 | Example 5 | — | — | — | — |
| 5 | Example 6 | — | — | — | — |
| 6 | DI Water | 127.96 | 117.71 | 146.31 | 92.09 |
| 7 | E6478² | 276.5 | 276.5 | 281.6 | 276.5 |
| 8 | Water | 856.2 | 856.2 | 871.9 | 856.2 |

¹Available as Mazon 1651 from BASF Corporation.
²Pigment paste E6478 available from PPG Industries consisting of 52% solids at a P:B of 1.22. Contains 0.324% by weight of the guanidine catalyst described in U.S. Pat. No. 7,842,762, the % by weight based on total weight of the pigment paste.

TABLE 12

| Charge | Material | I | J | K | L |
|---|---|---|---|---|---|
| 1 | Resin A | — | 924.63 | 881.16 | — |
| | Resin B | 908.56 | — | — | — |
| | Resin C | | | | 937.35 |
| 2 | Bis[2-(2- | 26.61 | 27.92 | 26.61 | 27.92 |
| | butoxyethoxy)ethoxy] | | | | |
| | methane¹ | | | | |
| 3 | Solution 2 of Ex. 3 | 28.51 | 29.92 | — | 29.92 |
| 4 | Example 5 | — | — | 14.55 | — |
| 5 | Example 6 | — | 52.17 | | — |
| 6 | DI Water | 92.34 | 82.16 | 133.69 | 122.92 |
| 7 | E6478² | 230.5 | — | 230.5 | — |
| | Pig. Paste of Ex. 9 | — | 189.9 | — | 189.9 |
| 8 | Water | 713.5 | 702 | 713.5 | 702 |

¹Available as Mazon 1651 from BASF Corporation.
²Pigment paste E6478 available from PPG Industries consisting of 52% solids at a P:B of 1.22. Contains 0.324% by weight of the guanidine catalyst described in U.S. Pat. No. 7,842,762, the % by weight based on total weight of the pigment paste.

### Evaluation of Electrodepositable Coating Compositions

The paints were coated on to cold-rolled steel (CRS) panels that are 4×6×0.032 inches and pretreated with CHEMFOS C700/DI (CHEMFOS C700 is a zinc phosphate immersion pretreatment composition available from PPG Industries, Inc.). These panels are available from ACT Laboratories of Hillside, Mich. The above described electrodepositable paint compositions were electrodeposited onto these specially prepared panels in a manner well known in the art by immersing them into a stirring bath at 32.2° C. and connecting the cathode of the direct current rectifier to the panel and connecting the anode of the direct current rectifier to the stainless-steel tubing used to circulate cooling water for bath temperature control. The voltage was increased from 0 to a set point voltage of 190V over a period of 30 seconds and then held at that voltage until the desired film thickness was achieved. This combination of time, temperature and voltage deposited a coating that when cured had a dry film thickness of 16-20 microns. Three panels were electrocoated for each paint composition. After electrodeposition, the panels were removed from the bath, rinsed vigorously with a spray of deionized water, and cured by baking for 25 minutes at 190° C. in an electric oven.

After electrodeposition, the panels were removed from the bath, rinsed vigorously with a spray of deionized water, and cured by baking for 25 minutes at 190° C. in an electric oven. Coated panel texture was evaluated using a Mitutoyo Surftest SJ-402 skidless stylus profilometer equipped with a 4 mN detector and a diamond stylus tip with a 900 cone and a 5 μm tip radius. The scan length, measuring speed, and data sampling interval were 48 mm, 1 mm/s, and 5 μm, respectively. The raw data was first filtered to a roughness profile according to ISO 4287-1997 3.1.6 using an Lc parameter of 2.5 mm and an Ls parameter of 8 μm before summarizing an Ra metric according to ISO 4287-1997 4.2.1, hereinafter referred to as Ra (2.5 mm). Ra values for compositions A to L are reported in Table 15.

The beverage can industry measures coverage of the thin coating inside a can using a WACO Enamel Rater instrument, which measures current flow through a 1% sodium chloride solution in an operating range from 0 to 500 mill amperes, when a 6.2-volt potential difference is applied between the outside of the can and a stainless-steel anode placed in the center of the salt solution (electrolyte) inside the can. The greater the coating coverage, the lower the current passed. This method was adopted for use in evaluating the knife blades with sharp edges, and the procedure is defined as the Enamel Rating Procedure herein. Specifically, the paints were coated on to knife blades pretreated with CHEMFOS C700/DI (CHEMFOS C700 is a zinc phosphate immersion pretreatment composition available from PPG Industries, Inc.). The knife blades are available from ACT Laboratories of Hillside, Mich. A stainless-steel beaker is the cathode and the test piece, the coated part, is electrically connected to the anode by first removing a portion of the coating using a Dremel Model 3000 tool with a 50-grit sanding band. The part is lowered into the 1% sodium chloride solution so that 3 inches of the knife blade edge is exposed to the solution and that a fixed surface area is below the surface of the electrolyte. A 6.2-volt potential difference is applied between the stainless-steel beaker and the coated knife blade, and the amount of current passed is an indication of the extent of coverage of the knife blade with the electrodeposited coating. The coated knife blades were visually inspected for evidence of defects (e.g., pinholes) and only those that had no defects on the coated front, back and back edges, were selected for testing. As a result, the current passed is a reflection of the degree of coverage of the electrodeposited coating on the sharp edge of the knife blade with a coating thickness between 16-20 microns. Since there is some variation from part to part, current measurements were taken on six separate parts and the results were averaged. Enamel rater results are reported in Table 15. This test method is referred to herein as the Enamel Rating Procedure.

To test edge corrosion, test panels were specially prepared from cold rolled steel panels, 4×12×0.032 inches, pretreated with CHEMFOS C700/DI and available from ACT Laboratories of Hillside, Michigan. The 4×12×0.3 2-inch panels were first cut into two 4×5¾-inch panels using a Di-Acro Hand Shear No. 24 (DiAcro, Oak Park Heights, Minnesota). The panels are positioned in the cutter so that the burr edge from the cut along the 4-inch edge ends up on the opposite side from the top surface of the panel. Each 4×5¾ panel is then positioned in the cutter to remove ¼ of an inch from one of the 5¾-inch sides of the panel in such a manner that the burr resulting from the cut faces upward from the top surface of the panel.

The above described electrodepositable paint compositions were then electrodeposited onto these specially prepared panels in a manner well known in the art by immersing them into a stirring bath at 32.2° C. and connecting the cathode of the direct current rectifier to the panel and connecting the anode of the direct current rectifier to the stainless-steel tubing used to circulate cooling water for bath temperature control. The voltage was increased from 0 to a set point voltage of 190V over a period of 30 seconds and then held at that voltage until the desired film thickness was achieved. This combination of time, temperature and voltage deposited a coating that when cured had a dry film thickness of 16-20 microns. Three panels were electrocoated for each paint composition. After electrodeposition, the panels were removed from the bath, rinsed vigorously with a spray of deionized water and cured by baking for 25 minutes at 190° C. in an electric oven.

These cured panels were then placed into a salt spray cabinet such that the burr along the 5¾-inch side of the panel was horizontal and at the top with the burr edge facing outward towards the spray. Correspondingly, the burr along the 3¾-inch side of the panel was vertical, and the burr edge faced backward. These panels were subjected to salt spray exposure for a period of seven days such that any areas along the 5¾-inch (145 mm) length of the burr, not well protected by the electrocoat will develop rust. The salt spray test is the same as that used for testing the knife blades and is described in detail in ASTM B 117. After the exposure to salt spray, the length of the burr still well protected by electrocoat, was measured (covered edge+rusted edge=145 mm). Due to panel-to-panel variation, the burr length of each of three panels was evaluated. The % of coverage remaining along the burr length was then calculated. The average % of coverage of the three burr lengths from the three individual panels was then averaged. This test method is referred to herein as the Burr Edge Coverage Test Method.

The results of the testing are shown in the table below.

TABLE 13
Comparison of Appearance, Enamel Rating, and Burr Edge Corrosion.

| | | | Additive | | Enamel | Burr Edge |
|---|---|---|---|---|---|---|
| | | | Level | Ra | Rater | Coverage |
| Paint | Catalyst | Additive | (%) | (2.5 mm) | (mA) | (%) |
| A | BCG | None | 0 | 0.208 | 209 | 3 |
| B | BCG | Solution 1 | 0.5 | 0.140 | 201 | 4 |
| C | BCG | Solution 1 | 0.75 | 0.169 | 214 | 1 |
| D | BCG | Solution 1 | 1.25 | 0.166 | 222 | 1 |
| E | BCG | Solution 2 | 0.2 | 0.226 | 192 | 5 |
| F | BCG | Solution 2 | 0.5 | 0.274 | 165 | 11 |
| G | BCG | Solution 2 | 0.75 | 0.440 | 145 | 62 |
| H | BCG | Solution 2 | 1.25 | 0.916 | 144 | 50 |
| I | BCG | Solution 2 | 0.75 | 0.182 | 134 | 13 |
| Comp. J | Bi | Solution 2 | 0.75 | 0.519 | 148 | 37 |
| Comp. K | BCG | Acrylic Microgel | 0.75 | 0.262 | 186 | 8 |
| L | Zn | Solution 2 | 0.75 | 0.200 | 141 | 33 |

The results show that addition of low molecular weight hydroxyl-functional polymer does not influence the enamel rating, regardless of the amount added (comparing Paints B, C, or D to Paint A). For high molecular weight hydroxyl-functional polymer, increasing the hydroxyl-functional polymer level had a negative impact on appearance but improved the enamel rater value. The hydroxyl-functional polymer type and level must be selected carefully to balance appearance and enamel rater or corrosion. Paint G, which contains hydroxyl-functional polymer, shows improved enamel rater and corrosion performance compared to an acrylic microgel additive (Paint K). The incorporation of a resin containing the reaction product of a polyepoxide, di-functional chain extender, and mono-functional reactant showed improved appearance (Paint I, Ra=0.182) compared to a system without such reaction product (Paint G, Ra=0.440). The results for Paints G, I, J, and L show that different catalysts are suitable with respect to edge coverage and corrosion protection, but Paint J, with a bismuth catalyst, had the poorest appearance compared to BCG and zinc catalysts.

It will be appreciated by skilled artisans that numerous modifications and variations are possible in light of the above disclosure without departing from the broad inventive concepts described and exemplified herein. Accordingly, it is therefore to be understood that the foregoing disclosure is merely illustrative of various exemplary aspects of this application and that numerous modifications and variations can be readily made by skilled artisans which are within the spirit and scope of this application and the accompanying claims.

1. An electrodepositable coating composition comprising:
(a) a hydroxyl-functional addition polymer comprising constitutional units, at least 70% of which comprise formula I:
—[—C(R¹)₂—C(R¹)(OH)—]— (I),
wherein each R^{t} is independently one of hydrogen, an alkyl group, a substituted alkyl group, a cycloalkyl group, a substituted cycloalkyl group, an alkylcycloalkyl group, a substituted alkylcycloalkyl group, a cycloalkylalkyl group, a substituted cycloalkylalkyl group, an aryl group, a substituted aryl group, an alkylaryl group, a substituted alkylaryl group, a cycloalkylaryl group, a substituted cycloalkylaryl group, an arylalkyl group, a substituted arylalkyl group, an arylcycloalkyl group, or a substituted arylcycloalkyl group, and the % based upon the total constitutional units of the hydroxyl-functional addition polymer;
(b) an active hydrogen-containing, ionic salt group-containing film-forming polymer;
(c) a curing agent; and
(d) an amine-containing curing catalyst and/or a zinc-containing curing catalyst.

2. The electrodepositable coating composition of claim 1, wherein each R¹ comprises hydrogen.

3. The electrodepositable coating composition of claim 1, wherein the amine-containing curing catalyst comprises a guanidine curing catalyst, an imidazole curing catalyst, an amidine, or any combination thereof.

4. The electrodepositable coating composition of claim 1, wherein the constitutional units comprising formula I comprise 70% to 95% of the hydroxyl-functional addition polymer, the % based upon the total constitutional units of the hydroxyl-functional addition polymer.

5. The electrodepositable coating composition of claim 1, wherein the hydroxyl-functional addition polymer further comprises constitutional units comprising the residue of a vinyl ester.

6. The electrodepositable coating composition of claim 1, wherein the hydroxyl-functional addition polymer is formed from polymerizing vinyl ester monomers to form an intermediate polymer comprising constitutional units comprising the residue of vinyl ester, and then hydrolyzing the constitutional units comprising the residue of vinyl ester of the intermediate polymer.

7. The electrodepositable coating composition of claim 6, wherein the residue of vinyl ester comprises 80% to 100% of the constitutional units comprising the intermediate polymer, the % based upon the total constitutional units of the intermediate polymer.

8. The electrodepositable coating composition of claim 5, wherein the vinyl ester comprises vinyl acetate, vinyl formate, or any combination thereof.

9. The electrodepositable coating composition of claim 1, wherein the hydroxyl-functional addition polymer has a theoretical hydroxyl-equivalent weight of 30 g/equivalent of OH to 200 g/equivalent of OH.

10. The electrodepositable coating composition of claim 1, wherein the hydroxyl-functional addition polymer has a theoretical hydroxyl value of 1,000 to 1,300 mg of KOH/g of hydroxyl-functional addition polymer.

11. The electrodepositable coating composition of claim 1, wherein the hydroxyl-functional addition polymer has a number molecular weight of 5,000 g/mol to 500,000 g/mol, as determined by Gel Permeation Chromatography using polystyrene calibration standards.

12. The electrodepositable coating composition of claim 1, wherein the hydroxyl-functional addition polymer has a weight average molecular weight of 5,000 g/mol to 500,000 g/mol, as determined by Gel Permeation Chromatography using polystyrene calibration standards.

13. The electrodepositable coating composition of claim 1, wherein the active hydrogen-containing, ionic salt group-containing film-forming polymer comprises an active hydrogen-containing, cationic salt group-containing film-forming polymer.

14. The electrodepositable coating composition of claim 1, wherein the active hydrogen-containing, ionic salt group-containing film-forming polymer comprises an active hydrogen-containing, anionic salt group-containing film-forming polymer.

15. The electrodepositable coating composition of claim 1, wherein the ionic salt group-containing film-forming polymer comprises a reaction product of a reaction mixture comprising:
(a) a polyepoxide;
(b) di-functional chain extender; and
(c) a mono-functional reactant.

16. The electrodepositable coating composition of claim 15, wherein the ratio of functional groups from the di-functional chain extender and the mono-functional reactant to the epoxide functional groups from the polyepoxide may be 0.50:1 to 0.85:1.

17. The electrodepositable coating composition of claim 15, wherein the reaction product has an epoxy equivalent weight of 700 to 1,500 g/equivalent.

18. The electrodepositable coating composition of claim 1, wherein
(a) the hydroxyl-functional addition polymer is present in an amount of 0.01% to 5% by weight;
(b) the active hydrogen-containing, ionic salt group-containing film-forming polymer is present in an amount of 40% to 90% by weight; and
(c) the curing agent is present in an amount of 10% to 60% by weight, the % by weight based on the total weight of resin solids of the electrodepositable coating composition.

19-22. (canceled)

23. A method of coating a substrate comprising electrophoretically applying the electrodepositable coating composition of claim 1 to at least a portion of the substrate.

24. A coated substrate having a coating comprising:
(a) a hydroxyl-functional addition polymer comprising constitutional units, at least 70% of which comprise formula I:
—[—C(R¹)₂—C(R¹)(OH)—]— (I),
wherein each R¹ is independently one of hydrogen, an alkyl group, a substituted alkyl group, a cycloalkyl group, a substituted cycloalkyl group, an alkylcycloalkyl group, a substituted alkylcycloalkyl group, a cycloalkylalkyl group, a substituted cycloalkylalkyl group, an aryl group, a substituted aryl group, an alkylaryl group, a substituted alkylaryl group, a cycloalkylaryl group, a substituted cycloalkylaryl group, an arylalkyl group, a substituted arylalkyl group, an arylcycloalkyl group, or a substituted arylcycloalkyl group;
(b) an active hydrogen-containing, ionic salt group-containing film-forming polymer different from the addition polymer;
(c) a curing agent; and
(d) an amine-containing curing catalyst and/or a zinc-containing curing catalyst.
